(19) United States
(12) Patent Application Publication
(10) Pub. No.: US 2018/0305972 A1
(43) Pub. Date: Oct. 25, 2018

(54) VACUUM INSULATED GLASS UNIT WITH GLASS-TO-METAL SEAL AND METHODS OF ASSEMBLING SAME

(71) Applicant: ASTRAVAC GLASS, INC., COLORADO SPRINGS, CO (US)

(72) Inventors: DAVID H. STARK, EVERGREEN, CO (US); SCOTT V. THOMSEN, SOUTH LYON, MI (US); JAMES E. ELLIS, TEMPE, AZ (US)

(73) Assignee: ASTRAVAC GLASS, INC., COLORADO SPRINGS, CO (US)

(21) Appl. No.: 15/765,462

(22) PCT Filed: Feb. 11, 2016
(86) PCT No.: PCT/US16/17626

§ 371 Date: Apr. 2, 2018

Related U.S. Application Data
(60) Provisional application No. 62/115,108, filed on Feb. 11, 2015.
(60) Provisional application No. 62/157,290, filed on May 5, 2015.
(60) Provisional application No. 62/157,299, filed on May 5, 2015.

(51) Int. Cl. E06B 3/66; E06B 3/677; E06B 3/663; B23K 1/06

(52) U.S. Cl. CPC E06B 3/6612; B23K 1/06; E06B 3/66357; E06B 3/677

(57) ABSTRACT

A vacuum insulated glass unit comprises first and second glass panes, each defining interior and exterior surfaces and lateral edges. The interior surfaces of the panes are opposing and spaced apart to define an inter-pane gap. A band of metal solder extends continuously between the interior surfaces and continuously around the peripheries of the panes but is inset from the lateral edges, thus defining an inter-pane cavity surrounded by the solder band and a channel disposed between the band and the lateral edges. The solder band is attached with hermetic glass-to-metal bonds to the interior surfaces of the panes, whereby the cavity is hermetically sealed with respect to the panes. A plurality of stand-offs is disposed within the cavity and extends between the interior surfaces. An adhesive material is disposed within the channel, extending between the interior surfaces and structurally bonding the panes across the inter-pane gap.

### CROSS-REFERENCE TO RELATED APPLICATIONS

This application is a 371 of International Application No. PCT/US16/17626, filed on Feb. 11, 2016, entitled VACUUM INSULATED GLASS UNIT WITH GLASS-TO-METAL SEAL AND METHODS OF ASSEMBLING SAME (Atty. Dkt. No. STRK-32916), which published as WO 2016/130854 on Aug. 18, 2016. Application No. PCT/US16/17626 claims priority to and/or benefit of U.S. Provisional Application No. 62/115,108, filed Feb. 11, 2015, entitled EDGE SEAL ASSEMBLIES FOR HERMETIC VACUUM INSULATING GLASS UNITS AND METHODS OF ASSEMBLING SAME (Atty. Dkt. No. STRK-32518), U.S. Provisional Application No. 62/157,290, filed May 5, 2015, entitled VACUUM INSULATED GLASS UNIT AND METHOD (Atty. Dkt. No. STRK-32600), and U.S. Provisional Application No. 62/157,299, filed May 5, 2015, entitled VACUUM INSULATED GLASS UNIT AND METHOD (Atty. Dkt. No. STRK-32601). Application Nos. PCT/US16/17626, 62/115,108, 62/157,290 and 62/157,299, and Publication No. WO 2016/130854 are incorporated by reference herein in their entirety.

### TECHNICAL FIELD

The following disclosure relates to multi-pane vacuum insulating glass units (hereinafter “VIGUs” or “VIGs”) for use in fenestration applications (e.g., windows and doors for buildings), windows for transportation vehicles (e.g., buses, trucks, automobiles, planes, trains, and ships), solar collector panels; glass units for supermarket refrigeration systems, glass units for beverage vending machines, and other applications where insulating glass units having extremely high thermal insulation values are needed. In particular, it relates to VIGUs utilizing a glass-to-metal seal to hermetically seal the vacuum cavity between the panes and methods of assembling same.

### BACKGROUND

Insulating glass units (also known as insulating glazing units or “IGUs” or “IGs”) and vacuum insulating glass units (also known as vacuum insulating glazing units or “VIGUs” or “VIGs”) are well known. Typical IGUs and VIGUs comprise two or more parallel but spaced-apart sheets of glass (also known as “panes” or “lites”) attached and/or sealed to one another around their respective peripheries. The enclosed gap between each pair of panes of glass defines a cavity bordered by the peripheral seal. In IGUs, the inter-pane cavity is filled with air or another insulating gas such as argon, krypton or xenon, whereas in VIGUs, the inter-pane cavity is “filled” with or contains a reduced-pressure atmosphere or a vacuum. Spacers (also known as “stand-offs,” “standoffs,” “pillars” or “suspenders”) may be disposed within the inter-pane gap of IGUs and VIGUs to maintain the gap and prevent the interior portions of the panes from touching one another in case of deflection. In the case of VIGUs, spacers are particularly necessary in order to support the panes of glass against the pressure of the outside air, which otherwise might distort or damage the glass, or cause the two adjacent panes of glass to come in contact with each other so as to produce a thermal “short circuit” (i.e., a thermally conductive path directly through the panes of glass).

Using vacuum to increase the insulating performance of window glazing components is not a new concept, and in fact many innovative approaches have been taught in the literature over the last 75 years. It is, however, readily observed by skilled practitioners of the art that the majority of the prior work relates to low-to-medium vacuum levels, i.e., vacuum levels within the range from about 760 torr (i.e., 1 torr=1 atmosphere of pressure at sea level) to about 10⁻³ torr. For purposes of this application, a “higher” level of vacuum is understood to correspond to a lower absolute pressure, e.g., a vacuum level of 10⁻⁴ torr is a higher vacuum than 10⁻³ torr. In a few cases the literature makes reference to the measured vacuum levels in glazing components, but in many cases the maintainable vacuum level must be interpreted from careful evaluation of the materials exposed to the vacuum enclosure, the methods used to create the vacuum seal and the methods used to produce the vacuum condition in the enclosed space.

While the literature describing vacuum insulating window glazing components may not rigorously define the vacuum levels, literature from other industries, such as the electronics industry, defines different vacuum levels and the types of materials and processing methods required to achieve and maintain those specified vacuum levels. The common distinction between medium-vacuum and high-vacuum devices is a vacuum level of 10⁻³ torr. In other words, the range of high-vacuum levels begins at about 10⁻³ torr and goes higher, i.e., in the direction toward and/or past 10⁻⁴ torr. In the case of VIGUs for windows, doors and other components, where it is desirable for the VIGUs to retain a prescribed minimum vacuum level for an extended operating lifetime (e.g., 25 years), a vacuum containment system capable of initially maintaining a higher level of vacuum (e.g., 10⁻⁵ torr), may be necessary.

High-vacuum insulating glass units (hereinafter “HVIGUs”) are VIGUs having a vacuum level in the inter-pane cavity of 10⁻³ torr or higher. One purpose of HVIGUs is to provide lower levels of conductive heat losses between temperature-controlled spaces and non-temperature-controlled spaces, or between different temperature-controlled spaces that are separated by this glazing unit (i.e., compared to VIGUs with low or medium-vacuum levels). In such cases, providing this desired lower level of conductive heat loss over a long period of time is desirable. Since the ambient conditions in the uncontrolled space, most commonly the external atmospheric environment, produce a variety of stresses including thermal, pressure and mechanical vibration, and since, to a lesser extent, this also happens in the conditioned space, various embodiments of the HVIGU will be more or less capable of surviving the applied stresses while maintaining the desired minimum vacuum level. Thus, the design lifetime, i.e., the period of time that the HVIGU will maintain its desired level of performance, is one of the performance features of the HVIGU.

In the case of VIGUs and HVIGUs, the periphery of the spaced-apart glass pane is sealed, typically along the edges, using some arrangement of sealing elements to isolate the evacuated inter-pane cavity from the surrounding atmospheric pressure. Since the primary objective of the VIGU or HVIGU is to provide a low thermally-conductive barrier between environmental spaces, each of which may have a higher or lower temperature with respect to the other, it is obvious to skilled practitioners of the art that the two panes of glass comprising a VIGU or HVIGU may reach temperature levels which vary distinctly from each other. In fact, for a given space-to-space temperature differential, the pane-to-pane temperature differential will typically increase as a function of reduced thermal conductivity of the VIGU or HVIGU. As a result of the temperature differential between the panes of glass, the panes may expand and contract differentially. This may also introduce differential movement of the spacers relative to one or both panes of glass.

For reference purposes, the outdoor-facing or outside-facing glass pane of an IGU/VIGU is typically referred to as lite #1, and the indoor-facing or inside-facing glass pane is typically referred to as lite #2. There are typically four glass surfaces of interest, denoted as surfaces 1, 2, 3 and 4. Surfaces 1 and 2 are, respectively, the outdoor-facing and indoor-facing surfaces of lite #1, and surfaces 3 and 4 are, respectively, the outdoor-facing and indoor-facing surfaces of lite #2. Thus, surfaces 2 and 3 are typically disposed on opposite sides of the inter-pane cavity of the IGU/VIGU/HVIGU.

As previously indicated, VIGUs are of interest for window applications because of their extremely high thermal insulating properties, with center-of-glass insulating or thermal resistance R values as high as R-13 or more, expressed in US units of British Thermal Units (i.e., BTUs) as ft²·^{c}F·hr/BTU which equates to conductive U-Values or U-Factors of 0.07 BTU/(hr·° F·ft²) or lower as expressed in US units. The conversion between US and SI units of R-value is 1 ft²·° F·hr/BTU=0.176110 K·m²/W, or_1 K·m²/W=5.678263 ft²·° F·hr/BTU.

Generally speaking, a VIGU must maintain a pressure (i.e., vacuum level) of less than 1 millitorr (i.e., 1×10⁻³ torr) over its desired 10-40 year life in order to maintain its high R-value (low U value). As a result, the seals of the VIGU must provide a hermetic bond between surface 2 of lite #1 and surface 3 of lite #2. A VIGU seal is herein referred to as “highly hermetic” for a stated number of years if the seal has a leak rate low enough to maintain a vacuum in the associated inter-pane cavity of 1×10⁻³ torr or higher (i.e., higher vacuum) for at least the stated number of years. In other words, there is a leak rate associated with a highly hermetic VIGU seal, but the leak rate is such that, over the rated time period, the vacuum level in the associated cavity will fall from an initial value of vacuum that is higher than 1×10⁻³ torr to a final value of vacuum that is not lower than 1×10⁻³ torr.

U.S. Pat. No. 8,944,308 B2 to Friedl et al., entitled “Method And Apparatus For Producing Multiple-Pane Insulating Glass Having A High-Vacuum Insulation,” discloses an apparatus and method for producing an insulating structural element from substrates. The substrates may be connected to one another at a periphery by applied pieces and may be insulated from one another by a vacuum. U.S. Pat. No. 8,944,308 B2 is incorporated by reference herein.

International Publication No. WO 2014/205193, entitled “Low-Temperature Bonding And Sealing With Spaced Nanorods,” discloses improved systems and methods for low-temperature bonding and/or sealing with spaced nanorods. In certain embodiments, the bond is achieved at room temperature with only pressure or at a temperature above room temperature (e.g., about 150° C. or less) at reduced pressure. Exemplary bonds are both mechanically strong and substantially impermeable to oxygen and moisture. WO 2014/205193 claims benefit of U.S. Provisional Application No. 61/837,814, filed Jun. 21, 2013. Both International Publication No. WO 2014/205193 and U.S. Provisional Application No. 61/837,814 are incorporated by reference herein.

### SUMMARY OF THE INVENTION

In one aspect, a vacuum insulated glass unit (VIGU) comprises a first lite of transparent or semi-transparent material with first and second surfaces and a second lite of transparent or semi-transparent material with third and fourth transparent surfaces. The lites are disposed such that the third surface faces the second surface, and the two surfaces are spaced apart to define an inter-lite gap between the second and third surfaces. A low emissivity coating is disposed on the entirety of the second and/or third surface except for an optional, edge-reduced region disposed in a continuous band around the perimeter of the second and/or third surface. At least one continuous band of metal-alloy solder hermetically bonds across the inter-lite gap between an interior portion of the optionally edge-reduced region of the second and/or third surface and an opposing region of the other surface to define a hermetically sealed cavity in a first portion of the inter-lite gap surrounded by the continuous band. A plurality of stand-offs are disposed within the cavity. An adhesive or epoxy material is disposed within a second portion of the inter-lite gap not surrounded by the continuous band and structurally bonds across the inter-lite gap between an exterior portion of the edge-reduced region of the second surface and an opposing region of the third surface.

In another aspect, a method for producing a VIGU as described above is provided that uses three soldering processes. In another aspect, a method for producing a VIGU as described above is provided that uses two soldering processes. In another aspect, a method for producing a VIGU as described above is provided that uses one soldering processes.

In another aspect, a method for producing a VIGU is provided that does not include an adhesive or epoxy material surrounding the continuous band of metal solder.

In a further aspect, a vacuum insulated glass unit (VIGU) comprises a first glass pane defining an interior surface and an exterior surface on opposite sides thereof and lateral edges extending therebetween and a second glass pane defining an interior surface and an exterior surface on opposite sides thereof and lateral edges extending therebetween. The second glass pane is disposed such that the interior surface of the second glass pane opposes the interior surface of the first glass pane, and the second glass pane further is spaced apart from the first glass pane to define an inter-pane gap between the opposing interior surfaces. A first band of metal solder extends continuously between the opposing interior surfaces of the first and second glass panes and is disposed continuously around the peripheries of the first and second glass panes but inset from the lateral edges of the first and second glass panes. An inter-pane cavity is defined in a first portion of the inter-pane gap that is surrounded by the first band of metal solder and a channel is defined in a second portion of the inter-pane gap that is between the first band of metal solder and the lateral edges of the glass panes. The first band of metal solder is attached with a first hermetic glass-to-metal bond to the interior surface of first glass pane and is attached with a second hermetic glass-to-metal bond to the interior surface of the second glass pane, whereby the inter-pane cavity is hermetically sealed with respect to the first and second glass panes. A plurality of stand-offs is disposed within the inter-pane cavity and extends between the opposing interior surfaces of the first and second glass panes. An adhesive material is disposed within the channel and extends between the opposing interior surfaces of the first and second glass panes and structurally bonds the first glass pane to the second glass pane across the inter-lite gap.

In one embodiment, the VIGU further comprises a low emissivity coating disposed on substantially all of the interior surface of the second glass pane except for an edge-reduced region disposed in a continuous band around the perimeter of the second pane. The second hermetic glass-to-metal bond from the first band of metal solder to the interior surface of the second glass pane is formed on a portion of the edge-reduced region.

In another embodiment, the VIGU further comprises a first relief cut formed in a portion of the interior surface of one of the glass panes bordering the lateral edge thereof, the first relief cut extending along the lateral edge, thereby reducing the thickness of the first-relief-cut portion of the glass pane by a first amount and increasing the thickness of the first-relief-cut portion of the inter-pane gap by the first amount. The adhesive material is disposed within the first-relief-cut portion of the inter-pane gap and the first band of metal solder is disposed in the remaining portion of the inter-pane gap. The thickness of the adhesive material is greater than the thickness of the first band of metal solder.

In yet another embodiment, a second relief cut is formed in a portion of the interior surface of one of the glass panes bordering the first relief cut, the second relief cut extending along the first relief cut, thereby reducing the thickness of the second-relief-cut portion of the glass pane by a second amount and increasing the thickness of the second-relief-cut portion of the inter-pane gap by the second amount, where the second amount is smaller than the first amount. The adhesive material is disposed within the first-relief-cut portion of the inter-pane gap and the first band of metal solder is disposed within the second-relief-cut portion of the inter-pane gap. The thickness of the first band of metal solder is greater than the thickness of the remaining interior portion of the inter-pane gap.

In still another embodiment, the first band of metal solder is formed from a solder alloy including tin (Sn), silver (Ag), titanium (Ti) and magnesium (Mg).

In a further embodiment, the VIGU further comprises a second band of metal solder extending continuously between the opposing interior surfaces of the first and second glass panes and continuously spaced apart from the first band of metal solder, whereby an inter-band gap is defined between the first and the second bands of metal solder. The second band of metal solder is attached with a third hermetic glass-to-metal bond to the interior surface of first glass pane and is attached with a fourth hermetic glass-to-metal bond to the interior surface of the second glass pane. The inter-pane cavity is further hermetically sealed with respect to the first and second glass panes.

In another embodiment, the lateral width of the inter-band gap between the first and second metal solder bands is within the range from 1 μm to 500 μm.

In yet another embodiment, the lateral width of the inter-band gap between the first and second metal solder bands is within the range from 500 μm to 1 mm.

In another aspect, a vacuum insulated glass unit (VIGU) comprises a first glass pane defining an interior surface and an exterior surface on opposite sides thereof and lateral edges extending therebetween and a second glass pane defining an interior surface and an exterior surface on opposite sides thereof and lateral edges extending therebetween. The second glass pane is disposed such that the interior surface of the second glass pane opposes the interior surface of the first glass pane. The second glass pane further is spaced apart from the first glass pane to define an inter-pane gap between the opposing interior surfaces. A first band of metal solder extends continuously between the opposing interior surfaces of the first and second glass panes and is disposed continuously around the peripheries of the first and second glass panes, whereby an inter-pane cavity is defined in a first portion of the inter-pane gap that is surrounded by the first band of metal solder. The first band of metal solder is attached with a first hermetic glass-to-metal bond to the interior surface of first glass pane and is attached with a second hermetic glass-to-metal bond to the interior surface of the second glass pane, whereby the inter-pane cavity is hermetically sealed with respect to the first and second glass panes. A plurality of stand-offs is disposed within the inter-pane cavity and extends between the opposing interior surfaces of the first and second glass panes.

In one embodiment, the VIGU further comprises a low emissivity coating disposed on substantially all of the interior surface of the second glass pane except for an edge-reduced region disposed in a continuous band around the perimeter of the second pane. The second hermetic glass-to-metal bond from the first band of metal solder to the interior surface of the second glass pane is formed on a portion of the edge-reduced region.

In another one embodiment, a VIGU further comprises a first relief cut formed in a portion of the interior surface of one of the glass panes bordering the lateral edge thereof, the first relief cut extending along the lateral edge, thereby reducing the thickness of the first-relief-cut portion of the glass pane by a first amount and increasing the thickness of the first-relief-cut portion of the inter-pane gap by the first amount. The first band of metal solder is disposed within the first-relief-cut portion of the inter-pane gap. The thickness of the first band of metal solder is greater than the thickness of the remaining interior portion of the inter-pane gap.

In yet another embodiment, the first band of metal solder is formed from a solder alloy including tin (Sn), silver (Ag), titanium (Ti) and magnesium (Mg).

In a still further embodiment, the VIGU further comprises a second band of metal solder extending continuously between the opposing interior surfaces of the first and second glass panes and continuously spaced apart from the first band of metal solder, whereby an inter-band gap is defined between the first and the second bands of metal solder. The second band of metal solder is attached with a third hermetic glass-to-metal bond to the interior surface of first glass pane and is attached with a fourth hermetic glass-to-metal bond to the interior surface of the second glass pane, whereby the inter-pane cavity is further hermetically sealed with respect to the first and second glass panes.

In another embodiment the lateral width of the inter-band gap between the first and second metal solder bands is within the range from 1 μm to 500 μm.

In a further embodiment, the lateral width of the inter-band gap between the first and second metal solder bands is within the range from 500 μm to 1 mm.

In another aspect, a method for making a vacuum insulated glass unit (VIGU) comprises providing a first glass pane defining an interior surface and an exterior surface on opposite sides thereof and lateral edges extending therebetween and providing a second glass pane defining an interior surface and an exterior surface on opposite sides thereof and lateral edges extending therebetween. A first band of metal solder is applied continuously around the periphery of the interior surface of the first glass pane but inset from the lateral edges of the first glass pane. A plurality of stand-offs is placed on the interior surface of the first glass pane disposed within the portion of the interior surface surrounded by the first band of metal solder. The second glass pane is positioned at a position proximate to, but spaced apart from, the first glass pane such that the interior surface of the second glass pane opposes the interior surface of the first glass pane to define an inter-pane gap between the opposing interior surfaces and defining an inter-pane cavity in that portion of the inter-pane gap surrounded by the first band of metal solder and defining a channel in that portion of the inter-pane gap between the first band of metal solder and the lateral edges of the glass panes. A first hermetic glass-to-metal bond is formed attaching the first band of metal solder to the interior surface of the first glass pane and a second hermetic glass-to-metal bond is formed attaching the first band of metal solder to the interior surface of second glass pane, whereby the inter-pane cavity is hermetically sealed with respect to the first and second glass panes. A structural adhesive is inserted into the channel, the structural adhesive extending between the opposing interior surfaces of the first and second glass panes and structurally bonding the first glass pane to the second glass pane across the inter-lite gap.

In one embodiment, the step of applying a first band of metal solder further comprises pre-tinning the interior surface of the first glass pane with a band of metal solder continuously around the periphery of the interior surface of the first glass pane.

In another embodiment, the step of applying a first band of metal solder further comprises placing solid pieces of metal solder around the periphery of the interior surface of the first glass pane.

In yet another embodiment, the step of forming a first hermetic glass-to-metal bond further comprises heating the first band of metal solder sufficient to liquefy at least portions of the first band of metal solder contacting the interior surface of the first glass pane continuously around the periphery of the first band of metal solder. Ultrasonic vibrations are applied to the liquefied portions of the solder of the first band of metal solder in contact with the interior surface of the first glass pane.

In still another embodiment, the step of forming a second hermetic glass-to-metal bond further comprises heating the first band of metal solder sufficient to liquefy at least portions of the first band of metal solder contacting the interior surface of the second glass pane continuously around the periphery of the first band of metal solder. Ultrasonic vibrations are applied to the liquefied portions of the solder of the first band of metal solder in contact with the interior surface of the second glass pane.

In a further embodiment, a second band of metal solder is applied on the interior surface of the first glass pane, the second band of metal solder being continuously spaced apart from the first band of metal solder, whereby an inter-band gap is defined between the first and second bands of metal solder. A third hermetic glass-to-metal bond is formed attaching the second band of metal solder to the interior surface of the first glass pane and a fourth hermetic glass-to-metal bond is formed attaching the second band of metal solder to the interior surface of second glass pane, whereby the inter-band gap is hermetically sealed with respect to the first and second glass panes.

In another aspect, a method for making a vacuum insulated glass unit (VIGU) comprises providing a first glass pane defining an interior surface and an exterior surface on opposite sides thereof and lateral edges extending therebetween and providing a second glass pane defining an interior surface and an exterior surface on opposite sides thereof and lateral edges extending therebetween. A first band of metal solder is applied continuously around the periphery of the interior surface of the first glass pane but inset from the lateral edges of the first glass pane and a second band of metal solder is applied continuously around the periphery of the interior surface of the second glass pane but inset from the lateral edges of the second glass pane. A plurality of stand-offs is placed on the interior surface of the first glass pane disposed within the portion of the interior surface surrounded by the first band of metal solder. The second glass pane is positioned at a position proximate to, but spaced apart from, the first glass pane such that the interior surface of the second glass pane opposes the interior surface of the first glass pane to define an inter-pane gap between the opposing interior surfaces and defining an inter-pane cavity in that portion of the inter-pane gap surrounded by the first band of metal solder and defining a channel in that portion of the inter-pane gap between the first band of metal solder and the lateral edges of the glass panes and further such that the first band of metal solder at least partially overlaps the second band of metal solder continuously around the periphery of the first band of metal solder. A first hermetic glass-to-metal bond is formed attaching the first band of metal solder to the interior surface of the first glass pane, a second hermetic glass-to-metal bond is formed attaching the first band of metal solder to the interior surface of second glass pane forming a second hermetic glass-to-metal bond attaching the first band of metal solder to the interior surface of second glass pane and a hermetic solder bond is formed attaching the first band of metal solder to the second band of metal solder, whereby the inter-pane cavity is hermetically sealed with respect to the first and second glass panes. A structural adhesive is inserted into the channel, the structural adhesive extending between the opposing interior surfaces of the first and second glass panes and structurally bonding the first glass pane to the second glass pane across the inter-lite gap.

In yet another aspect, a method for making a vacuum insulated glass unit (VIGU) comprises providing a first glass pane defining an interior surface and an exterior surface on opposite sides thereof and lateral edges extending therebetween and providing a second glass pane defining an interior surface and an exterior surface on opposite sides thereof and lateral edges extending therebetween. A first band of metal solder is applied continuously around the periphery of the interior surface of the first glass pane. A plurality of stand-offs is placed on the interior surface of the first glass pane disposed within the portion of the interior surface surrounded by the first band of metal solder. The second glass pane is positioned at a position proximate to, but spaced apart from, the first glass pane such that the interior surface of the second glass pane opposes the interior surface of the first glass pane to define an inter-pane gap between the opposing interior surfaces and defining an inter-pane cavity in that portion of the inter-pane gap surrounded by the first band of metal solder. A first hermetic glass-to-metal bond is formed attaching the first band of metal solder to the interior surface of the first glass pane and a second hermetic glass-to-metal bond is formed attaching the first band of metal solder to the interior surface of second glass pane, whereby the inter-pane cavity is hermetically sealed with respect to the first and second glass panes.

### BRIEF DESCRIPTION OF THE DRAWINGS

For a more complete understanding, reference is now made to the following description taken in conjunction with the accompanying Drawings in which:

FIG. 1A shows a cross-sectional side view of a VIGU in accordance with one aspect, the cross-section being taken along line 1A-1A of FIG. 1B;

FIG. 1B shows a top view of the VIGU of FIG. 1A;

FIG. 2A shows a cross-sectional side view of a VIGU in accordance with another aspect, the cross-section being taken along line 2A-2A of FIG. 2B;

FIG. 2B shows a shows a top view of the VIGU of FIG. 2A;

FIGS. 3A-3C show assembly of a VIGU in accordance with a further aspect, wherein:

FIG. 3A shows a cross sectional side view of a VIGU during assembly, wherein solder has been applied to interior opposing surfaces of the panes by pre-tinning and stand-offs have been positioned on one pane;

FIG. 3B shows a cross sectional side view of the VIGU of FIG. 3A during further assembly, wherein the pre-tinned solder on the interior opposing surfaces of the panes is placed into aligned contact;

FIG. 3C shows a cross sectional side view of the VIGU of FIGS. 3A and 3B during further assembly, wherein the pre-tinned solder has been reflowed until the interior opposing surfaces of the panes are contacting at least some of the stand-offs.

FIGS. 4A-4C show assembly of a VIGU in accordance with still another aspect, wherein:

FIG. 4A shows a cross sectional side view of a VIGU during assembly, wherein solder has been applied to interior surface of a first pane by pre-tinning and stand-offs have been positioned on the first pane;

FIG. 4B shows a cross sectional side view of the VIGU of FIG. 4A during further assembly, wherein the pre-tinned solder on the interior surface of the first pane is placed into contact with the opposing interior surface of a second pane but the stand-offs are not in contact with the opposing interior surface of the second pane;

FIG. 4C shows a cross sectional side view of the VIGU of FIGS. 4A and 4B during further assembly, wherein the pre-tinned solder on the first pane has been reflowed until the interior opposing surfaces of the panes are contacting at least some of the stand-offs;

FIGS. 5A-5C show assembly of a VIGU in accordance with yet another aspect, wherein:

FIG. 5A shows a cross sectional side view of a VIGU during assembly, wherein unmelted solder pieces and stand-offs are positioned on the first pane;

FIG. 5B shows a cross sectional side view of the VIGU of FIG. 5A during further assembly, wherein the solder pieces positioned on the interior surface of the first pane are placed into contact with the opposing interior surface of a second pane but the stand-offs are not in contact with the opposing interior surface of the second pane;

FIG. 5C shows a cross sectional side view of the VIGU of FIGS. 5A and 5B during further assembly, wherein the solder pieces are reflowed until the interior opposing surfaces of the panes are contacting at least some of the stand-offs;

FIG. 6A shows a top view of a VIGU having a solder seal formed thereon in accordance with another aspect, the stand-offs being omitted for clarity;

FIG. 6B shows a glass pane and solder preforms used for assembly of the VIGU of FIG. 6A;

FIG. 6C shows the solder preforms of FIG. 6B positioned on the glass pane prior to reflowing during assembly of the VIGU; and

FIG. 7 shows a cross-sectional side view of a VIGU in accordance with a further aspect, wherein the completed VIGU does not include an adhesive surrounding the hermetic metal seal.

### DETAILED DESCRIPTION

For purposes of this application, although in appropriate usage vacuum insulating glazing units capable of maintaining vacuum levels of 10⁻³ torr or higher may be termed as “high-vacuum insulating glazing units” or “high-vacuum insulating glass units” (i.e., “HVIGU” or, in the plural, “HVIGUs”), this application will hereinafter refer to both vacuum insulating glazing units and high-vacuum insulating glazing units as VIGs or VIGUs.

Further for purposes of this application, unless otherwise specifically denoted, the term “ hermetic” as applied to a material or a seal shall mean that the material or seal has a helium leak rate less than or equal to 1×10⁻¹² atm.·cc/sec. More preferably, a hermetic material or seal may have a helium leak rate less than or equal to 1×10⁻¹³ atm.·cc/sec. Still more preferably, a hermetic material or seal may have a helium leak rate less than or equal to 1×10⁻¹⁴ atm.·cc/sec. Even more preferably, a hermetic material or seal may have a helium leak rate less than or equal to 1×10⁻¹⁵ atm.·cc/sec.

Still further for purposes of the application, unless otherwise specifically denoted, the term “structural adhesive” shall refer to relatively strong adhesives that are normally used well below their glass transition temperature, an important property for polymeric materials, above which polymers are rubbery and below which they are glassy. Common examples of structural adhesives include, but are not limited to, epoxies, cyanoacrylates, toughened acrylics, polyurethanes, anaerobics, phenolics and vinyl acetates. Such adhesives can carry significant stresses, and lend themselves to structural applications.

In preferred embodiments of the described VIGU assemblies, the glass used for the panes or lites is tempered glass. It will be appreciated that while the use of tempered glass provides many mechanical and thermal advantages when used as the glass lites for a VIGU, annealed or heat-strengthened glass may also be used for the described construction of the VIGU assemblies. One advantage of using tempered glass for the panes of the VIGUs is that, due to the high surface compression of tempered glass, the stand-offs can be placed much further apart (from one another) than when using annealed or heat-strengthened glass. The thermal conductivity of a system or array of stand-offs is proportional to the square of the distance between the centers of the stand-offs. Thus, keeping all aspects of an individual stand-off constant, then doubling the distance between stand-offs (i.e., in both the X and Y dimensions) will reduce the thermal conductivity of the system of stand-offs by 75%. Put another way, doubling the distance between stand-offs will increase the thermal resistance of the system of stand-offs by a factor of 4 times. It is for this and other reasons, including many code requirements, that use of tempered glass for VIGUs is preferred.

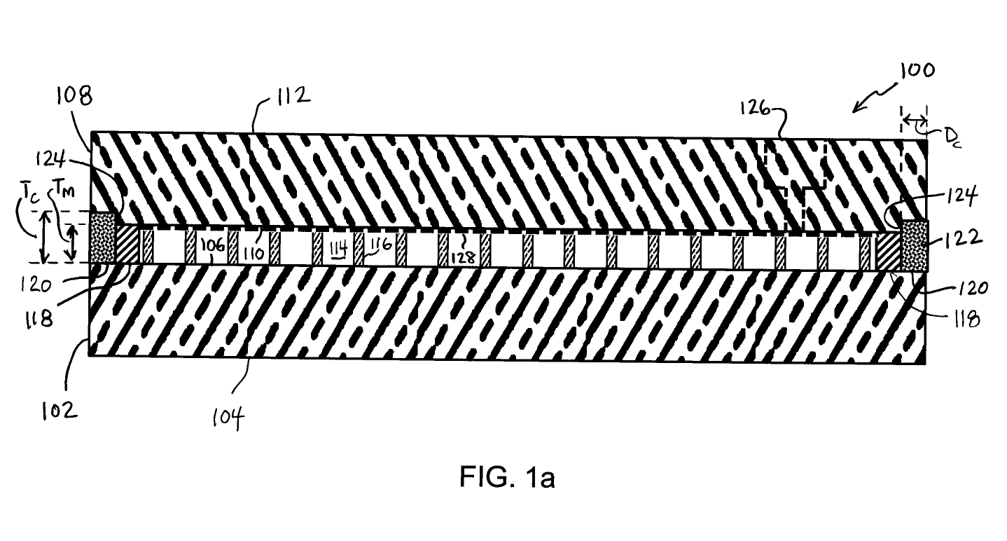

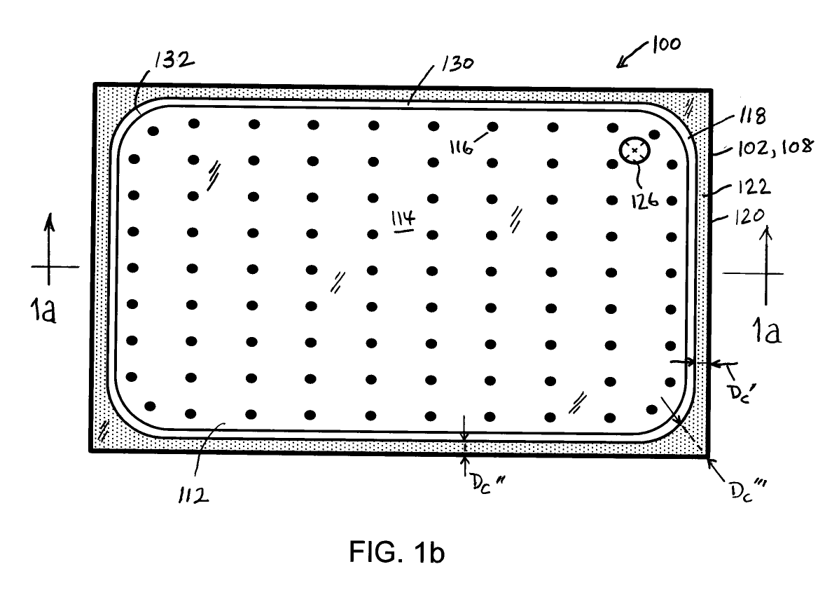

Referring now to FIGS. 1A and 1B, there is illustrated a VIGU in accordance with one aspect. Referring first to FIG. 1A, VIGU 100 includes a first glass pane 102 (traditionally called “lite #1”) having an exterior surface 104 (traditionally called “surface 1”) and interior surface 106 (traditionally called “surface 2”) and a second glass pane 108 (traditionally called “lite #2”) having an interior surface 110 (traditionally called “surface 3”) and an exterior surface (traditionally called “surface 4”). Note that when VIGU 100 is installed in a structure, the exterior surface 104 traditionally faces the outside and the exterior surface 112 traditionally faces the interior of the structure. The panes 102, 108 are spaced-apart from one another, thereby defining the upper and lower boundaries of an inter-pane cavity 114 therebetween. Positioned within the inter-pane cavity 114 is a plurality of stand-offs 116. The stand-offs 116 contact at least one of the opposing interior surfaces 106, 110 of the glass panes 102, 108, and in many cases, contact both opposing interior surfaces.

Referring now also to FIG. 1B, a metal seal 118 extends between the opposing interior surfaces 106, 110 of the glass panes 102, 108, and is disposed completely around the periphery of the panes, thereby defining the lateral boundary of the inter-pane cavity 114. The upper and lower surfaces of the metal seal 118 are bonded, respectively, to the opposing interior surfaces 106, 110 of the glass panes 102, 108 to form a hermetic glass-to-metal seal surrounding the inter-pane cavity 114. The glass-to-metal seal 118 is capable of reliably maintaining a vacuum within the inter-pane cavity 114 for an extended period of time. In preferred embodiments, the metal seal 118 if formed entirely of solder extending between the interior glass surfaces 106, 110. In more preferred embodiments, the solder of the metal seal 118 is so-called “active solder,” which is typically applied using combined heat and ultrasonic vibration.

The metal seal 118 of the VIGU 100 may be inset by a distance, denoted D_{C}, from the outer edges of the glass panes 102, 108 thereby defining a channel 120 extending laterally around the periphery of the VIGU. A layer of non-hermetic structural adhesive 122 may be provided in the channel 120. The structural adhesive 122 is bonded to the interior surfaces 106, 110 of the glass panes 102, 108 with a glass-to-adhesive bond. The mechanical strength of structural adhesive 122 with its glass-to-adhesive bond is one component of the overall mechanical bond between the two glass panes 102, 108, the second component being the mechanical strength of the metal seal 118 with its glass-to-metal bond.

As best seen in FIG. 1A, the thickness of the adhesive channel 120, denoted T_{C}, may be different than the thickness of the metal seal 118, denoted T_{M}, where the respective thicknesses are measured in the direction perpendicular to the interior surfaces 106, 110 of the glass panes. In preferred embodiments, the thickness T_{C} of the adhesive channel 120 is greater than the thickness T_{M} of the metal seal 118; however, in other embodiments thickness T_{C} may be equal to, or smaller than, thickness T_{M}. In many cases, the thickness T_{M} of the metal seal 118 is quite small because the thickness of the inter-pane cavity 114 is made as small as possible to reduce the overall thickness of the VIGU 100. In such case, it may become difficult to insert the structural adhesive 122 into the channel 120 if T_{C} is the same or smaller than T_{M}. A relief cut 124 may be provided at the edge of one or both glass panes 102, 108 to widen the channel 120 such that T_{C} is greater than T_{M}. In the illustrated embodiment, the relief cut 124 is provided in the interior surface 110 of second pane 108 such that T_{C} is greater than T_{M}.

As best seen in FIG. 1B, the inset depth D_{C} of the cavity 120 (i.e., between the metal seal 118 and the edge of the glass pane 102, 108) that receives the structural adhesive 122 may vary at different points around the periphery of the VIGU 100. In the illustrated embodiment of FIG. 1B, the inset depth D_{C}′ along the short edge may be different from the inset depth D_{C}″ along the long edge, and the inset depth D_{C}′″ at the corners of the VIGU may be different from both. In some embodiments, the entire channel 120 may be filled with the structural adhesive 122, whereas in other embodiments, only a portion of the channel may be filled with the adhesive. In still other embodiments, the amount of the channel 120 filled with the structural adhesive 122 may vary as the inset depth D_{C} varies.

The VIGU 100 may further include a drilled hole 126 formed through one of the glass panes 102, 108 for subsequent placement of a vacuum septum for evacuating the inter-pane cavity 114 after the hermetic seals are established. In the illustrated embodiment, a evacuation hole 126 is provided on the second pane 108, however, in other embodiments a evacuation hole may be provided on the first pane 102. In still other embodiments, for example when the VIGU 100 is assembled in a vacuum, the VIGU 100 may not have a evacuation hole.

The VIGU 100 may further include a low-e coating 128 disposed on one or more surfaces 104, 106, 110, 112 of the glass panes 102, 108. The low-e coating 128 is typically provided on at least one of the interior surfaces 106, 110 to reduce the radiated energy between the two glass panes 102, 108 since the opposing interior surfaces are so close to one another.

In one embodiment of the VIGU 100, the hermetic cavity 114 is created using a metal seal 118 comprising one or more ultrasonically soldered active metal-alloy solders adhered to the opposing interior surfaces 106, 110 (i.e., surfaces 2 and 3) of the VIGU to create the hermetically sealed cavity between these two inside surfaces of the VIGU. The VIGU 100 of this embodiment also includes an array of stand-offs 116 that maintain the physical separation of the glass panes 102, 108 (i.e., lites #1 and #2), as well as a structural adhesive 122 or epoxy that surrounds the exterior of the hermetic solder seal 118 and is bonded to the opposing interior surfaces 106, 110 of the glass panes.

In one embodiment, the VIGU 100 has a low-e coating 128 extending over the entire cavity-facing surface 110 of the second glass pane 108. In another embodiment of the VIGU 100, the second glass pane 108 (lite #2) contains an edge-deleted low-e coating 128 on its cavity-facing surface 110, which is VIGU surface 3. Alternatively, the low-e coating 128 may be disposed on the first glass pane 102 (lite #1) on the cavity-facing surface 106, which is VIGU surface 2, or on both surfaces 2 and 3. The low-e coating 128 may be deleted (removed) from the edge of the lite 108 by relief cut 124, or by other means including physical abrasion and chemical solvents, to a distance towards the center of the lite at least as far as where the ultrasonically-soldered metal-alloy 118 will be applied. Whether or not this length of deletion is necessary depends on: 1) the adhesion properties of the low-e coating 128 to its glass surface 106, 110 (the low-e coating 128 must have sufficient shear and peel strength that it will not delaminate from the glass 102, 108 during the life of the VIGU 100 when the VIGU is used in its intended application and environment); 2) the adhesion strength in shear and peel of the chosen structural adhesive 122 to the low-e coating 128; and 3) whether an extremely hermetic solder bond can be achieved to the low-e coating 128 or through the low-e coating to the underlying glass surface 106, 110 by ultrasonically soldering an active solder to either the glass surface or to the low-e coating.

A preferred active solder for the metal seal 118 is a flux-free and lead-free solder called S-Bond 220M, produced by S-Bond Technologies, LLC of Lansdale, Pa. U.S.A. This solder is composed principally of Sn—Ag—Ti—Mg. Ultrasonic energy is used during soldering to allow/cause the solder to hermetically bond to glass 106, 110 or an appropriate low-e coating 128, thereby forming the metal seal 118. The preferred ultrasonic frequency range for soldering to glass 106, 110 or an appropriate low-e coating 128 using an active solder such as S-Bond 220M is within the range from 10,000 Hz to 40,000 Hz, although lower or higher frequencies may sometimes be used. In some other cases the ultrasonic frequency range is within the range from 10,000 Hz to 60,000 Hz.

As previously described, disposed within the inner perimeter of the soldered seal 118 is the array of stand-offs 116. In various embodiments of VIGU 100, ultrasonic application of the solder to surface 106 of glass pane 102 and positioning of the stand-offs 116 onto surface 106 may be performed in either order, i.e. first the placement of the stand-offs 116 onto the surface 106 of the lite 102 and then secondly, ultrasonically pre-tinning the surface of the lite 102; or alternatively, first ultrasonically pre-tinning the surface 106 of the lite 102 followed by placement of the stand-offs 116 onto the surface 106 of the lite 102. Surrounding the outer perimeter of the soldered seal 118 is the structural adhesive 122 or epoxy in the cavity or channel 120 that surrounds the hermetic soldered seal. The structural adhesive 122 or epoxy is bonded to the interior surfaces 106, 110 (VIGU surfaces 2 and 3). An optional hole 126 may be provided through one of the glass panes 102, 108 for a pump-out tube assembly. A pump-out tube assembly (not shown) is typically disposed proximate to one corner of the VIGU and is used to evacuate the hermetic cavity 114 contained between the VIGU surfaces 2 and 3 subsequent to formation of the hermetic cavity by use of the active metal solder to create the glass-to-metal seal 118.

According to literature released by S-Bond Technologies, LLC, the S-Bond® solders such as aforementioned S-Bond 220M solder feature the addition of titanium and/or rare earth elements to conventional solder alloy bases. It is believed that these active elements migrate to any interface and react or interact with the opposing material surface to either remove oxides and nitrides and transport them into the bulk of the solder as an inert material or adhere to them. It is believed that this process occurs while solder is molten, after the thin oxide “skin” that forms on the surface of the molten solder is broken, thus allowing contact between the bulk solder and the substrate surface. The breaking of this skin is referred to as “activation,” and is done by application of a low level of mechanical shear forces at the interface between the solder material and the substrate. The level of shear required is small and can be delivered by the application of high frequency vibration to the parts to be joined or to the bulk solder when it is molten.

The S-Bond 220M solder (and other preferred active solders) have a shear strength in the range of 5,000 psi to 6,000 psi and have high ductility, similar to other tin-silver solders. Hermeticity between the S-Bond 220M solder (and preferred active solders) and a substrate (e.g., glass panes 102, 108) can be achieved with bond line widths as low as 2 mm. The shear strength of adhesives and epoxies vary significantly.

For the VIGU 100, the ratio of the width of the metal seal 118 (which may be formed from relatively more expensive active solder) to the width of the structural adhesive 122 (which may be formed from relatively less expensive adhesive or epoxy), where the respective widths are measured in the direction parallel to the interior surfaces 106, 110 of the glass panes, depends on several variables, including but not limited to: 1) the desired width of the solder bond 118 to obtain sufficient hermeticity with an adequate safety factor (for end-use conditions, the size of the VIGU and the thermal environment in which it will be used); 2) the height T_{C} of the pocket/channel 120 for the structural adhesive 122 and this height's interaction with the ease or difficulty of injecting an adhesive or epoxy into this material's cavity between the two lites of the VIGU; and 3) the optimization of the amount of active solder and adhesive or epoxy to achieve a low or the lowest cost for the combined use of both materials.

It will be appreciated that the advantages of using “active solder” for the metal seals 118 of the VIGU 100 in the embodiments illustrated in FIG. 1A and 1B and described herein include: 1) that the active solder is ductile and thus the VIGU 100 can withstand some differential movement of first glass pane 102 (lite #1) relative to second glass pane 108 (lite #2) without the metal seals 118 losing the hermetic glass-to-metal bond necessary to maintain the vacuum level within the cavity 114; 2) that active solder can be ultrasonically soldered to the glass with both the solder and the glass (e.g., panes 102, 108) at combined temperatures and times below those where tempered glass will begin to lose some or all of its tempered strength; and 3) the active solder, when properly ultrasonically soldered onto the glass surfaces (e.g., surfaces 106, 110), forms a hermetic bond with the surface of the glass, i.e., a hermetic glass-to-metal bond.

With respect to FIGS. 1A and 1B, it will be further appreciated that although an opening for an evacuation hole 126 is shown formed though the second glass pane 108, this evacuation hole could instead be through the first glass pane 102. It will be still further appreciated that although the low-e coating 128 is shown disposed on the interior surface 110 of the second glass pane 108, a low-e coating could alternatively be disposed on one or both vacuum cavity facing surfaces 106, 110 of either lite 102, 108. It will be yet further appreciated that although the stand-offs 116 are shown placed on what is shown as the interior surface 106 of the bottom lite 102, the stand-offs could alternatively have been placed on the interior surface 110 of the upper lite 108. It will be still further appreciated that although in FIGS. 1A and 1B the second lite 108 is shown to be above the first lite 102, the VIGU 100 could alternatively be assembled with the first lite above the second lite.

Referring now again to FIG. 1B, there is shown a top view of the VIGU 100 of FIG. 1A. Illustrated are: 1) the hermetic ultrasonically-soldered metal seal 118 disposed completely around the periphery of the panes 102, 108 and between the interior-facing surfaces 106, 110 of the panes, thereby creating an inter-pane cavity 114 for holding a vacuum; 2) the array of stand-offs 116 disposed between the two glass panes 102, 108 and within the inner perimeter of the ultrasonically-soldered bond 118; and 3) a structural adhesive 122 disposed in the cavity/channel 120 surrounding the lateral edge of hermetic soldered seal 118 and bonded to the interior surfaces 106, 110 of the glass panes. Although not shown, stand-offs 116 of an appropriate height to contact the interior surfaces 106, 110 of the panes also may be provided in the region in which the structural adhesive 122 or epoxy is contained.

Further in FIG. 1B, it will be seen that the continuous metal seal 118 may comprise a plurality of straight portions 130 connected to a plurality of corner sections 132. Although in the illustrated embodiment the four corner sections 132 are shown to be curved (i.e., to have a radius), one or more corner sections 132 may be square (i.e., form a right angle) or have other shapes.

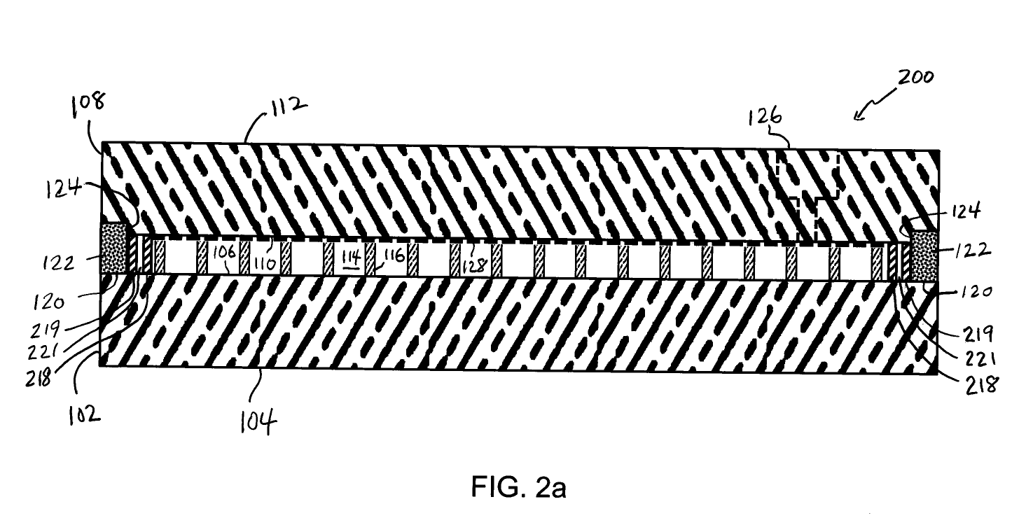

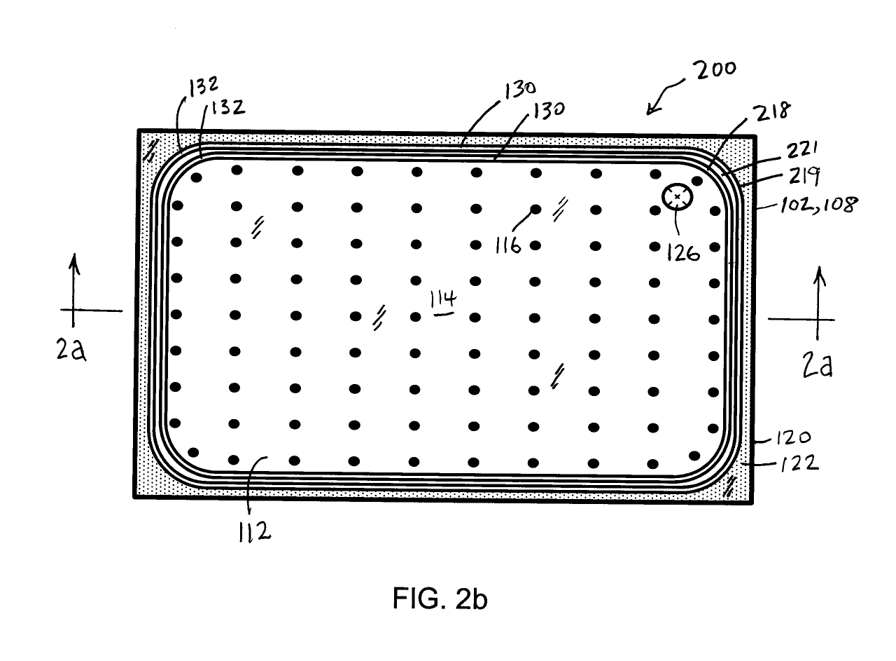

Referring now to FIGS. 2A and 2B, there is illustrated a VIGU in accordance with another aspect. The VIGU 200 of FIGS. 2A and 2B is substantially similar in construction to the VIGU 100 previously shown and described in connection with FIGS. 1A and 1B. In this respect, identical reference numbers will be used for identical elements. However, whereas the VIGU 100 includes a single hermetic metal-alloy seal 118 surrounding the cavity 114, the VIGU 200 includes multiple concentric hermetic metal-alloy seals surrounding the cavity. In the illustrated embodiment, two concentric metal-alloy seals are provided, inner metal seal 218 and outer metal seal 219, however, additional concentric metal seals may be provided in other embodiments. Each metal seal 218, 219 is independently bonded to the interior surfaces 106, 110 of the panes 102, 108 and separated spaced-apart from the other metal seals to form a continuous gap 221 therebetween. The multiple concentric metal seals 218, 219 with continuous gap 221 all surrounding the cavity 114 provide redundancy and additional leak resistance for the VIGU 200.

In VIGU 200, for example, if a crack initiates (i.e., starts) in the hermetic glass-to-metal solder joint between one of the metal seals 218, 219 and one of the glass panes 102, 108, then this crack might eventually propagate (i.e., grow in length) and pass through the entire width of that respective solder bond joint. Although this event might cause a of loss of hermeticity for the respective one of the metal seals 218 or 219 in which the crack first occurred, the remaining metal seal would remain intact and vacuum tight. Further, the continuous gap 221 between the metal seals 218, 219 would halt the propagation of the crack so that it could not move into and damage the remaining metal seal. The gap 221 between solder bonds of the seals 218, 219 only needs to be wide enough to ensure physical separation between the two reflowed solder seals. In one embodiment of the VIGU 200, the lateral width of the inter-band gap 221 between the first and second metal solder bands 218, 219 is within the range from 1 μm to 500 μm. In another embodiment of the VIGU 200, the lateral width of the inter-band gap 221 between the first and second metal solder bands 218, 219 is within the range from 500 μm to 1mm.

The VIGU 200 further includes an array of spacers 116 inside the inner perimeter of the inner soldered metal seal 218. The structural adhesive 122 or epoxy surrounds and/or abuts the outer perimeter of the outer soldered metal seal 219. Although not shown, stand-offs 116 of an appropriate height to contact the interior surfaces 106,110 of the VIGU 200 may also be placed in the regions/channels 120 in which the structural adhesive 122 or epoxy is contained.

It will be appreciated that the VIGU 200 shown in FIGS. 2A and 2B can have one low-e coating 128 on either of the interior surfaces 106, 110 or employ a low-e coating on both surfaces. In still other embodiments, the low-e coating may be omitted.

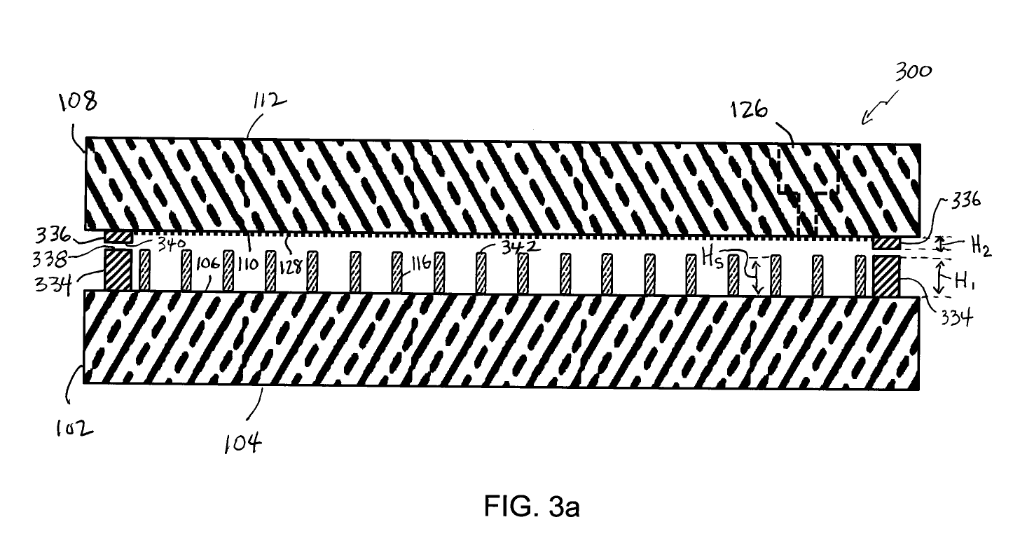

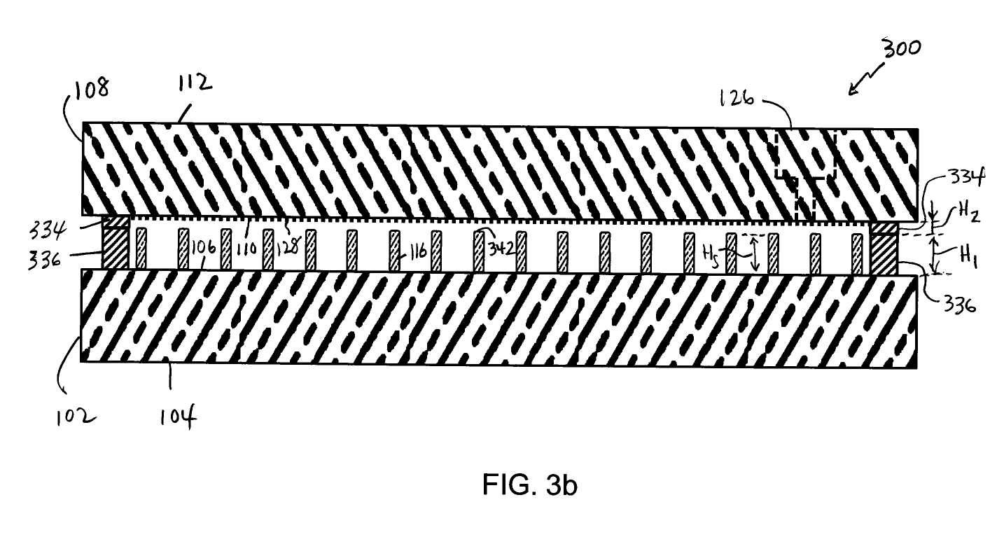

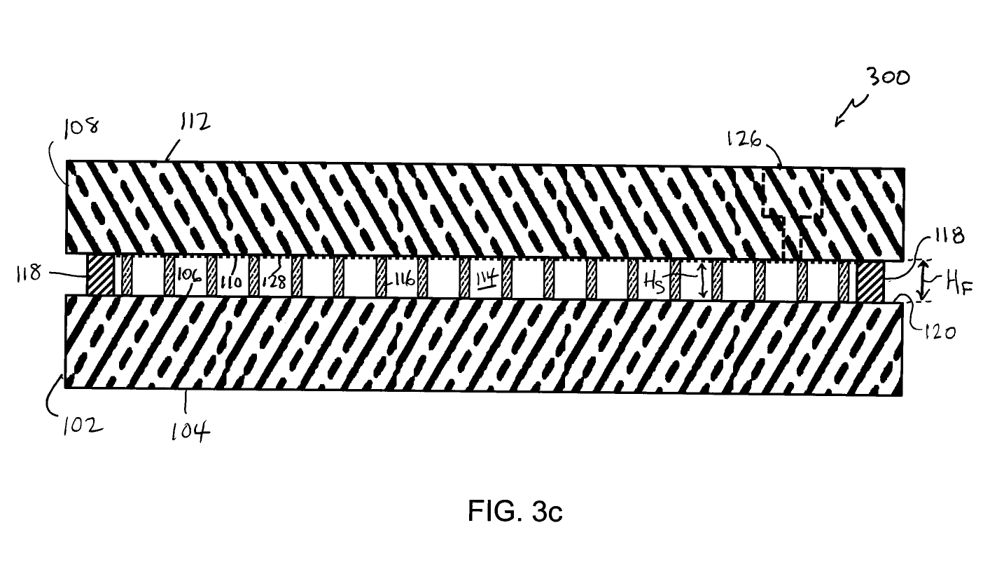

Referring now to FIGS. 3A-3C, there is illustrated the assembly of a VIGU in accordance with another aspect. The VIGU 300 of FIGS. 3A-3C is substantially similar in construction to the VIGU 100 previously shown and described, and in this respect, identical reference numbers will be used for identical elements. As further described herein, the VIGU 300 may be assembled using three separate soldering processes.

Referring first to FIG. 3A, the VIGU 300 is shown only partially assembled. The first two soldering processes have been performed, namely, the pre-tinning of the interior surface 106 (VIGU surface 2) of the first glass pane 102 and the pre-tinning of the interior surface 110 (VIGU surface 3) of the second glass pane 108. These two pre-tinning processes create, respectively, a first pre-tinned metal element 334 on the lower interior surface 106 and a second pre-tinned metal element 336 on the upper interior surface 110. It will be appreciated that each pre-tinned metal element 334, 336 is disposed completely around the periphery of the respective glass pane 102, 108 to which it is applied, resulting in respective configurations (when viewed from above, i.e., through the glass pane 108 in a direction perpendicular to the surface 112) similar to that of seal 118 in FIG. 1B. Further, the two pre-tinned metal elements 334, 336 have substantially similar layouts (when viewed from above) such that the two metal elements can be subsequently aligned with one another (when viewed from above) for further assembly.

The first two soldering processes (i.e., the pre-tinning processes just described) may be performed in any order, e.g., the pre-tinning of the interior surface 106 may be performed first, or the pre-tinning of the interior surface 110 may be performed first, or the pre-tinning of both interior surfaces 106 and 110 may be performed simultaneously. Preferably, the two pre-tinning processes are performed using ultrasonically activated metal-alloy solder to form the pre-tinned metal elements 334, 336. Preferably, the metal-alloy solder of the respective pre-tinned metal elements 334, 336 is hermetically bonded to the respective interior surface 106, 110 of the glass lites 102, 108, or optionally, to the low-e coating 128 which may be on either or both surfaces 106 or 110.

Referring still to FIG. 3A, assembly of the VIGU 300 further includes placing a plurality of stand-offs 116 on the interior surface(s) 106, 110 of one or both glass panes (lites) 102, 108. In the illustrated embodiment, the plurality of stand-offs 116 is placed on interior surface 106 of glass pane 102. The relative order of the pre-tinning operations applying the pre-tinned metal element 334, 336 to the interior surfaces 106, 110 relative to the placement of the stand-offs onto the interior surfaces may be performed in any order, i.e., by first placing the stand-offs 116 on the interior surface 106, 110 of the lite or lites and then ultrasonically pre-tinning the interior surfaces of the lites; or alternatively, by first ultrasonically pre-tinning the interior surface of the lites and then placing the stand-offs onto the surface of the lite or lites. The placement of the stand-offs 116 may be performed when the pre-tinned metal elements 334, 336 are in either a solid state or in a liquid state, or before the pre-tinning operations are performed.

Referring still further to FIG. 3A, after performing the two pre-tinning processes, the second glass pane 108 is positioned above the first glass pane 102 such that the pre-tinned metal elements 334, 336 are aligned with one another (when viewed from above) completely around the periphery of the metal elements. The alignment of the pre-tinned metal elements 334, 336 need not be absolute, i.e., there may be some partial overhang of one metal element 334, 336 relative to the other, however, the two pre-tinned metal elements 334, 336 must at least partially overlap, if not completely overlap, continuously around the entire periphery of the metal elements 334, 336 such that a continuous band may be formed in a subsequent reflow operation. The alignment of the pre-tinned metal elements 334, 336 may be performed when the pre-tinned metal elements are in either a solid state or in a liquid state.

It will be appreciated that the application of ultrasonically applied metal-alloy solder may sometimes be referred to as “solder pre-tin”, but is also known by those skilled in the art by this and other names or terms including, but not limited to, “applying solder pre-tin,” “pre-tinning the surface of a lite” and “pre-tin soldering.” Additionally, the terms “pretin” and “pre-tin” are interchangeable as are “pretinning” and “pre-tinning.” Further, in the solid state of the active metal-alloy solder after the solder has been ultrasonically applied to the surface of one or both lites and the solder is allowed or forced to cool to solidification, this solid-state solder (as opposed to “liquid-state solder” or “molten solder”) is often referred to as “pre-tinned solder.” Additionally, the lite onto which the active solder has been ultrasonically soldered may be referred to as “the pre-tinned lite.” When the temperature of the pre-tinned lite is at or above the liquidus temperature of the metal solder, the pre-tinned solder might remain molten, depending on conditions surrounding the pre-tinned solder.

Referring yet further to FIG. 3A, during assembly of the VIGU 300, each of the pre-tinned metal elements 334, 336 has an associated height (denoted, respectively, H₁ and H₂) measured from a respective inward-facing surface 338, 340 to the respective interior surface 106, 110 of the glass plane to which it is attached. Preferably, the heights H₁ and H₂ are respective minimum heights around the entire continuous element. Similarly, each stand-off 116 has an associated height (denoted H_{S}) measured from an inward facing surface 342 of the stand-off to the interior surface 106, 110 to which it is attached. Preferably, height H_{S} is a maximum height for all of the stand-offs 116 in the plurality of stand-offs for the VIGU 300. The sum of the minimum heights H₁ and H₂ of the pre-tinned metal elements 334, 336 (i.e., the value H₁+H₂) is preferably greater than the maximum height H_{S} of the stand-offs 116 that were or will be placed on the interior surfaces 106, 110. This allows the two solder pre-tins 334, 336 to be subsequently placed in continuous contact (see FIG. 3B) around the periphery of the pre-tins. It will be appreciated that if either or both of the interior surfaces 106, 110 is coated with a low-e coating 128, then the thickness of the low-e coating must be added to the maximum height H_{S} to determine the desired value for the sum of heights H₁+H₂.

As previously described, after both lites 102, 108 have had their appropriate surfaces 106, 110 ultrasonically and hermetically solder pre-tinned to form the pre-tinned metal elements 334, 336, the VIGU 300 is pre-assembled by aligning the two lites so that the center of the top lite 108 is centered above the center of the bottom lite 102 and the pre-tinned solder 336 on the bottom surface 110 of the top lite is aligned above the pre-tinned solder 334 on the top surface 106 of the bottom lite. The alignment of the pre-tinned metal elements 334, 336 may be performed when the pre-tinned metal elements are in either a solid state or in a liquid state.

Referring now to FIG. 3B, after aligning (i.e., as viewed from above) the pre-tinned metal element 334 (which is bonded to the interior surface 110) with the pre-tinned metal element 336 (which is bonded to the interior surface 106), the glass panes 102 and 108 are moved together until the respective opposing inwardly-facing surfaces 338, 340 of the pre-tinned metal elements 334, 336 are brought into contact with one another. As shown in FIG. 3B, the sum of the heights H₁ and H₂ of the pre-tinned metal elements 334, 336 is greater (taller) than the height H_{S} of the stand-offs 116, when the two solder pre-tins are brought into contact. Accordingly the inward inward-facing surfaces 342 of the stand-offs 116 may not be in contact with the opposing inward-facing surface of the opposite glass pane (or alternatively, with the low-e coating 128 on the opposing inward-facing surface). The moving of the glass panes 102, 108 to bring the opposing faces 338, 340 of the pre-tinned metal elements 334, 336 into contact with one another may be performed when the pre-tinned metal elements are in either a solid state or in a liquid state.

Referring now to FIG. 3C, the VIGU 300 is shown in substantially complete form (except the structural adhesive 122 is not shown). After bringing the inwardly-facing surfaces 338, 340 of the pre-tinned metal elements 334, 336 into contact with one another (FIG. 3B), the third soldering process is performed. The third soldering process is reflowing the opposing pre-tinned metal elements 334, 336 so they combine together to form the hermetically bonded metal seal 118 joining the first glass pane 102 to the second glass pane 108 and thereby sealing the periphery of the inter-pane cavity 114. The third solder process (i.e., reflowing) may be performed by heating the pre-tinned metal elements 334, 336 on interior surfaces 106, 110 to a temperature at or above the liquidus temperature of the solder alloy from which the pre-tinned metal elements are formed. As the solder of the two pre-tinned metal elements 334, 336 melts and combines, the two lites 102, 108 move towards one another until the interior surfaces 106, 110 (including any low-e coating 128 or other performance enhancing coating thereon) contact some or all of the stand-offs 116. Interior surface 110 may come into contact with some or all of the top surfaces 342 of the stand-offs 116 due to the weight of lite 108, or alternatively, due with the use of an external load (pressure) applied to the exterior surface 112 and/or 104 of the VIGU 300. During reflowing, the pre-tinned metal elements 334, 336, which have the combined total height of H₁+H₂, at least partially melt and subsequently solidify into the continuous metal seal 118, which has a final height that is less than the value of H₁+H₂. It is believed that allowing the final height H_{F} of the metal seal 118 to be determined by actual contact of the interior surfaces 106, 110 with the stand-offs 116 while the material of the seals is liquid provides VIGU 300 with improved tolerance for variation in the thickness of the glass panes 102, 108 and for variation in the height of the stand-offs 116 compared with VIGUs having a predetermined seal height.

In some embodiments where the pre-tinned solders on one or both lites 102, 108 are still liquid and sufficiently hot when the pre-tinned metal elements 334, 336 are brought into contact with one another, the reflowing necessary to form the metal seal 118 having a hermetic glass-to-metal bond between the two interior surfaces 106, 110 may occur without adding more heat to one or both solder pre-tins. In other embodiments, additional heat and/or ultrasonic vibration energy must be applied to the pre-tinned solders on lites 102, 108 to cause the pre-tinned metal elements 334, 336 to combine and form a metal seal 118 having a hermetic glass-to-metal bond between the two interior surfaces 106, 110. Ultrasonic frequencies ranging from 10,000 Hz to 40,000 Hz may be used for the ultrasonic vibration as these frequencies are understood to break up any surface oxides on the pre-tinned surfaces of the earlier-applied solder pre-tins 334, 336 helping assure a hermetic soldered bondline between the interior surfaces 106, 110 of the two lites 102, 108. In some other cases the ultrasonic frequency is within the range from 10,000 Hz to 60,000 Hz. Once the two solder pre-tins 334, 336 have been combined to form a hermetic seal 118 and the interior surface 110 of the lite 108 is in contact with the top surfaces 342 of some or all of the stand-offs 116 inside the periphery of the resulting hermetic bondline, the solder bondline is allowed to cool (or made to cool) past the point of solidification.

After the hermetic glass-to-metal seal has been formed between the metal element 118 and the interior surfaces 106, 110 of the glass panes 102, 108, the resulting inter-pane cavity 114 may be evacuated via the evacuation hole 126 (e.g., using a septum) to create a vacuum in the cavity. The channel 120 between the lateral outer edges of the metal element 118 and the lateral edges of the glass panes 102, 108 may be filled with the structural adhesive 122 (FIG. 1A) to increase the mechanical strength of the VIGU 300.

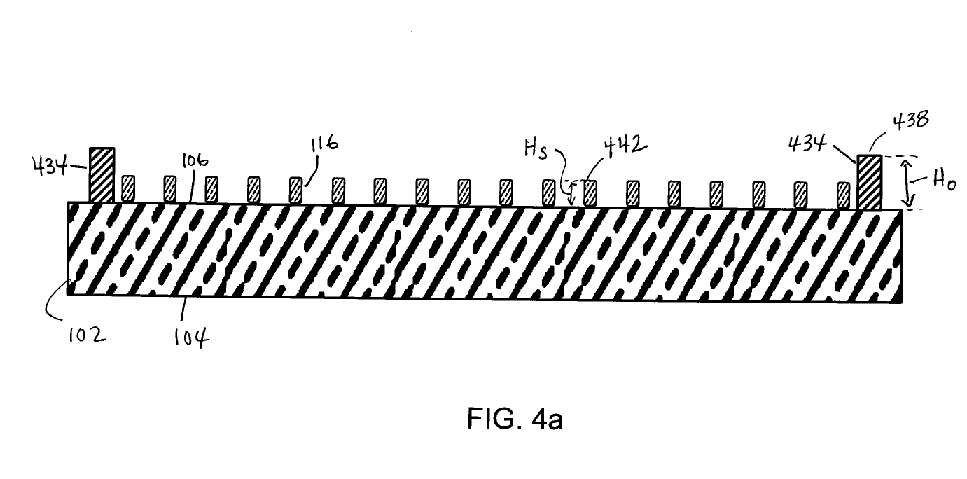

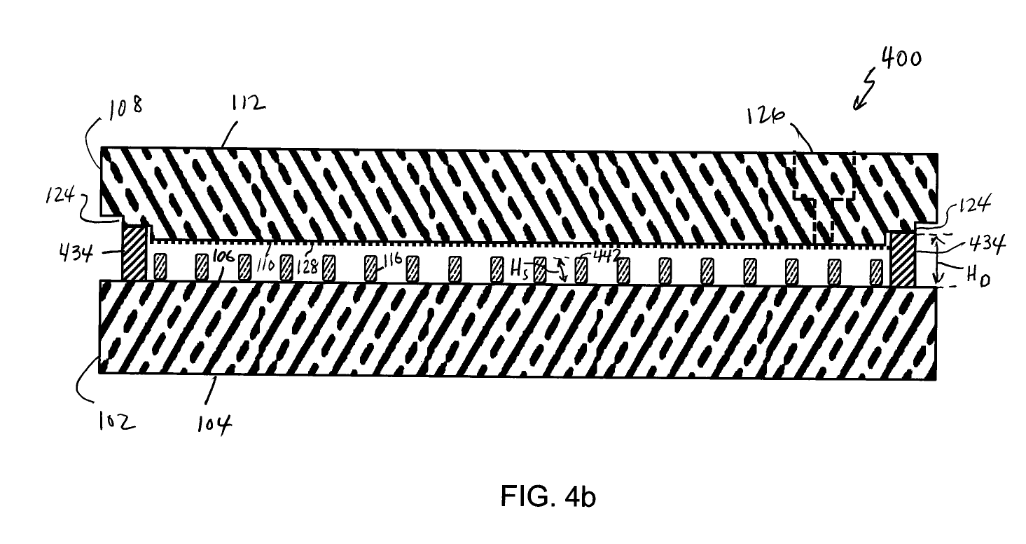

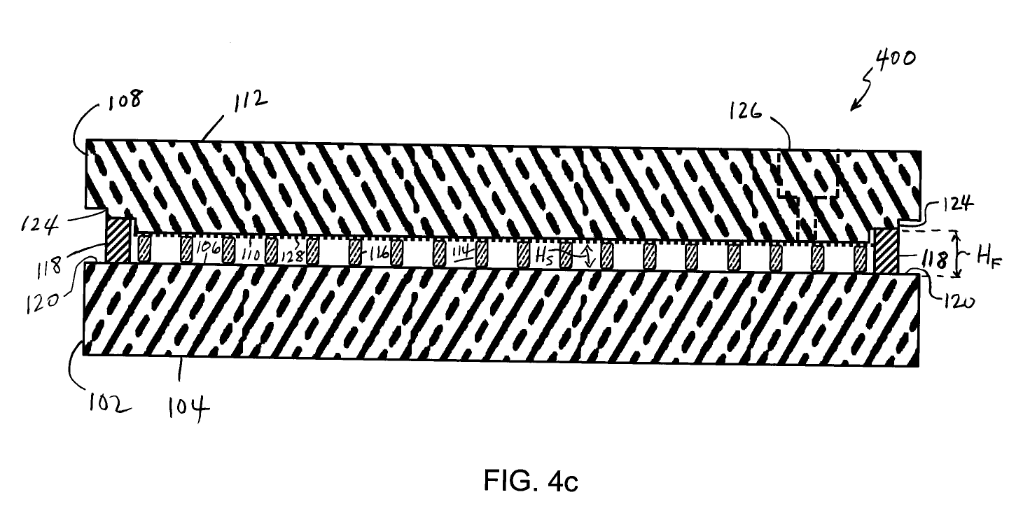

Referring now to FIGS. 4A-4C, there is illustrated the assembly of a VIGU in accordance with another aspect. The VIGU 400 of FIGS. 4A-4C is substantially similar in construction to the VIGU 100 previously shown and described, and in this respect, identical reference numbers will be used for identical elements. As further described herein, the VIGU 400 may be assembled using two separate soldering processes.

Referring first to FIG. 4A, the first glass pane (lite) 102 of the VIGU 400 is shown. A first soldering process is performed wherein a pre-tinned metal element 434 is formed on the interior surface 106 of the glass pane 102. It will be appreciated that the pre-tinned metal element 434 is disposed completely around the periphery of the glass pane 102 to which it is applied, resulting in a configuration (when viewed from above) similar to that of seal 118 in FIG. 1B. Preferably, the pre-tinned metal element 434 is ultrasonically soldered onto the interior surface 106 of the glass pane 102 to form a hermetic bond with interior surface 106. An array of stand-offs 116 are placed on the same interior surface 106 of the glass pane 102 as the pre-tinned solder 434 and within the inside periphery of the continuous band of pre-tinned solder 434.

The pre-tinned metal element 434 has an associated original height H_{O} measured from an inward-facing surface 438 to the surface 106 to which it is attached. Preferably, the original height H_{O} is the minimum height of the pre-tinned metal element 434 around the entire continuous element. Similarly, each stand-off 116 has an associated height H_{S} measured from an inward facing surface 442 of the stand-off to the surface 106 to which it is attached. Preferably, the original height H_{O} of the pre-tinned metal element 434 is greater than the height H_{S} of the stand-offs 116.

The order in which the solder 434 is ultrasonically applied to the lite 102 and the placement of the stand-offs 116 onto the surface 106 of the lite 102 can be performed in either order, i.e. first placing the stand-offs and then ultrasonically pre-tinning the surface 106 to form metal elements 434, or alternatively, first ultrasonically pre-tinning the surface of the lite and then placing the stand-offs onto the surface of the lite.

Referring now to FIG. 4B, the second glass pane 108 of the VIGU 400 is also illustrated, and the second glass pane is shown aligned (e.g., centered) above the first glass pane 102 and in the same orientation. The glass panes 102, 108 are moved towards one another until the top 438 (FIG. 4A) of the pre-tinned band of solder 434 that was previously pre-tinned onto the interior surface 106 of the glass pane 102 contacts the interior surface 110 of the aligned glass pane 108 (or alternatively, until it contacts the low-e coating 128, if present). The percentage of area of the solder on the upper surface 438 of the pre-tinned metal element 434 actually in contact with the interior surface 110 of the pane 108 relative to the total area of the upper surface 438 depends on the flatness of the solder's upper surface 438 as well as the flatness of the region on interior surface 110 intended to be in contact with the solder.

When the second glass pane 108 is moved into contact with the pre-tinned metal element 434, it will be appreciated that the upper surface 442 of the stand-offs 116 may not contact the interior surface 110 of the pane 108 (or alternatively, may not contact the low-e coating 128 of the pane, if present).

Referring now to FIG. 4C, the VIGU 400 is shown in substantially complete form (except the structural adhesive 122 is not shown). The second soldering process in assembly of the VIGU 400 is reflowing the pre-tinned metal element 434 to create a hermetic glass-to-metal seal between the solder element 434 and each of the interior surfaces 106, 110 of the glass panes 102, 108. In some cases, ultrasonic vibration energy may be applied to glass pane 102, glass pane 108 or both during the reflowing operation. In some cases, glass panes 102 and 108 are pressed towards each other during the reflowing operation. In some cases, as the glass pane 108 is brought into contact with the pre-tinned metal element 434, if the temperature of the pre-tinned band is below the liquid (i.e., liquidus) temperature of the solder, heat may be applied to either or both of glass pane 102 and/or 108 to raise the solder temperature to above its liquid temperature where the solder is in contact with the interior surface 110 of the glass pane 108. In some other embodiments, radiant energy including, but not limited to, infrared radiation and/or laser radiation may be transmitted through the transparent glass panes 102, 108 onto the solder of the pre-tinned metal element 434 to directly raise the temperature of the solder (i.e., by absorption of some or all of the radiant energy). The solder of the pre-tinned metal element 434 may also be heated by various means including, but not limited to induction heating and/or infrared heating during reflowing. Preferably, the temperature of the glass lite 108 in the region to be soldered to the pre-tinned metal element 434 is at or above the liquidus temperature of the solder in the pre-tinned metal element.

In some embodiments, ultrasonic energy may be applied to one or both lites 102, 108 when at least a portion of the solder of the pre-tinned metal element 434 is liquid and in contact with the interior surface 110 of lite 108, to cause the solder to become hermetically bonded to the interior surface 110. The interior surface 110 may or may not have a low-e coating 128 on the glass where the solder of the metal element 434 is bonded to the surface 110.

During reflowing, pressure may be applied to bias the two panes 102, 108 towards each other while the solder of the pre-tinned metal element 434 is liquid, thereby causing the two panes to move until the interior surface 110 (including any low-e coating 128 or other performance enhancing coating thereon) contacts the top surfaces 442 of some or all of the stand-offs 116. This applied pressure may be supplied by the weight of second pane 108, or by an outside force applied perpendicular to the first outer surface 104, or by an outside force applied perpendicular to the second outer surface 112, or some combination of external forces applied perpendicular to both surfaces 104 and 112. During reflowing, the pre-tinned metal elements 434, which have the original height H_{O}, at least partially melt and subsequently solidify into the continuous metal seal 118, which has the final height H_{F}, where the value of H_{F} is less than the value of H_{O}. It is believed that allowing the final height H_{F} of the metal seal 118 to be determined by actual contact of the interior surfaces 106, 110 with the stand-offs 116 while the material of the seals is liquid provides VIGU 400 with improved tolerance for variation in the thickness of the glass panes 102, 108 and for variation in the height of the stand-offs 116 compared with VIGUs having a predetermined seal height.

In some embodiments, after the pre-tinned metal element 434 of active metal-alloy solder has been completely ultrasonically bonded to the interior surface 110 of pane 108 during reflowing (having been previously bonded to the interior surface 106 of pane 102), the solder is allowed, or alternatively forced, to cool to a temperature at or below its associated solidification temperature (thereby becoming the metal seal 118). Allowing or forcing the solder to cool to or below its solidification temperature in a timely manner may require forced partial cooling of first lite 102 and/or second lite 108, or another method to cause the solder to become solid.

After the hermetic glass-to-metal seal has been formed between the metal seal element 118 and the interior surfaces 106, 110 of the glass panes 102, 108, the resulting inter-pane cavity 114 may be evacuated via an evacuation hole 126 (e.g., using a septum) to create a vacuum in the cavity. The channel 120 between the lateral outer edges of the metal element 118 and the lateral edges of the glass panes 102, 108 may be filled with the structural adhesive 122 (FIG. 1A) to increase the mechanical strength of the VIGU 400. Optionally, a relief cut 124 may be provided along the later edge of one or more of the glass panes 102, 108 to make the channel 120 wider, thereby simplifying placement of the structural adhesive 122 into the channel 120.

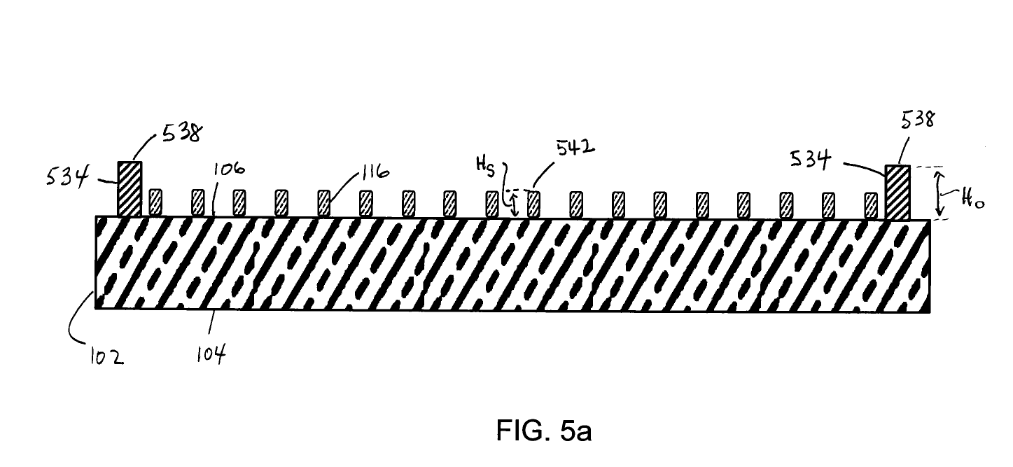

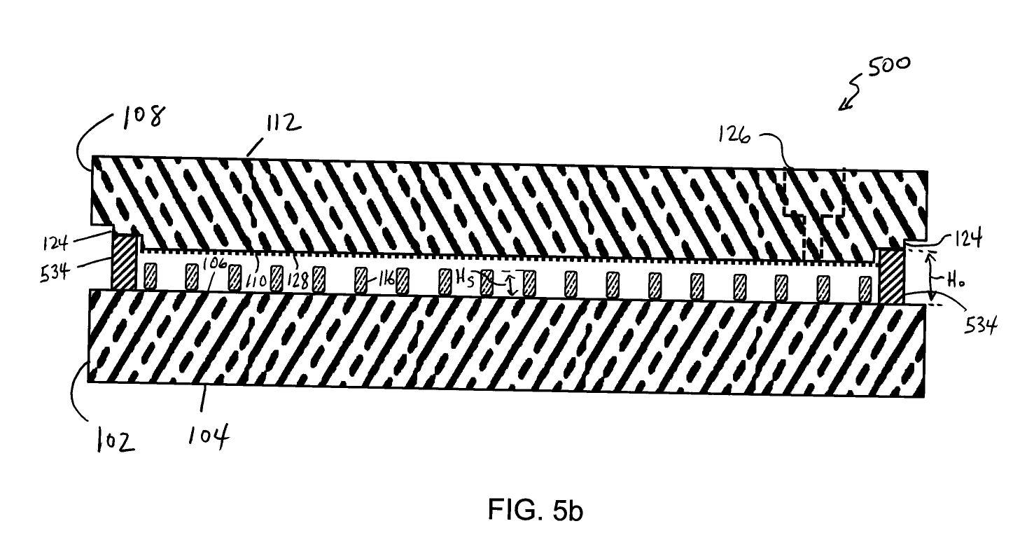

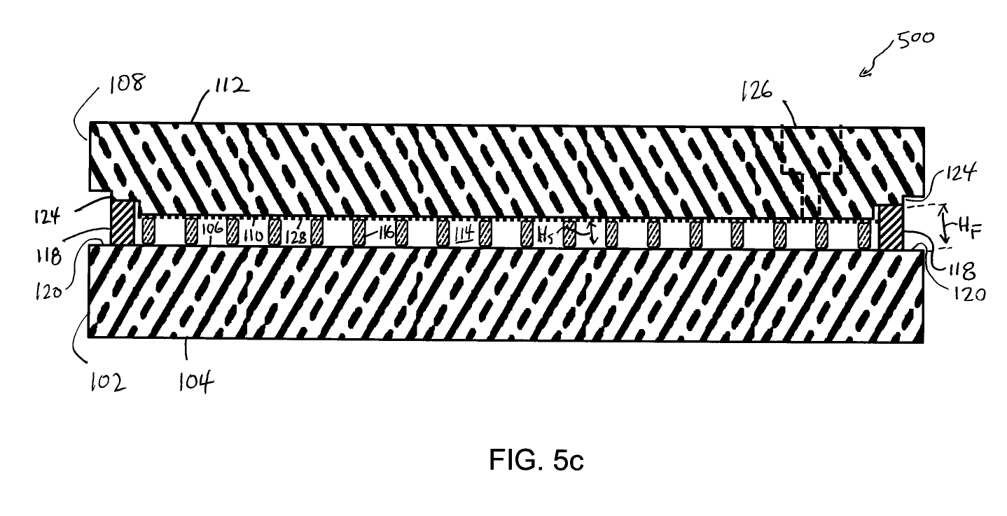

Referring now to FIGS. 5A-5C, there is illustrated the assembly of a VIGU in accordance with another aspect. The VIGU 500 of FIGS. 5A-5C is substantially similar in construction to the VIGU 100 previously shown and described, and in this respect, identical reference numbers will be used for identical elements. As further described herein, the VIGU 500 may be assembled using a single soldering process.

Referring first to FIG. 5A, the first glass pane 102 of the VIGU 500 is shown. One or more pieces of metal alloy solder 534 are placed on the interior surface 106 of the glass pane 102 to form a band disposed completely around the periphery of the pane, resulting in a configuration (when viewed from above) similar to that of seal 118 in FIG. 1B. It will be appreciated that while the solder band or pieces 534 are positioned on the surface 106, they are not necessarily bonded to the surface. In some cases, the solder band or pieces 534 may be tack-soldered to the surface 106 to maintain their position during subsequent processing, but it is not necessary to have a hermetic bond between the solder 534 and the glass surface 106 at this point.

An array of stand-offs 116 are placed on the same interior surface 106 of the glass pane 102 as the pre-placed solder band or pieces 534 and within the inside periphery of the solder piece or pieces. Preferably, the pre-placed solder pieces 534 have an original height, H_{O}, which is greater than the height, H_{S}, of the stand-offs. The order in which the solder band or pieces 534 are placed onto the surface 106 of the pane relative to the placing of the stand-offs 116 onto the same surface can be performed in either order, i.e., first placing the stand-offs 116 and then placing the solid solder pieces 534 onto the surface of the lite, or alternatively, first placing the solid solder pieces 534 onto the surface of the lite and then placing the stand-offs 116 onto the surface of the lite.

Referring now to FIG. 5B, the second glass pane 108 of the VIGU 500 is also illustrated, and the second glass pane is shown aligned (e.g., centered) above the first glass pane 102 and in the same orientation. The glass panes 102, 108 are moved towards one another until the top(s) 538 (FIG. 5A) of the pre-placed solder band/pieces 534 that were previously placed onto the interior surface 106 of the glass pane 102 contact the interior surface 110 of the aligned glass pane 108 (or alternatively, until they contact the low-e coating 128, if present). The percentage of area of the solder on the upper surface 538 of the solder band/pieces 534 actually in contact with the interior surface 110 of the pane 108 relative to the total area of the upper surface 538 depends on the flatness of the solder's upper surface 538 as well as the flatness of the region on interior surface 110 intended to be in contact with the solder pieces.

As best seen in FIG. 5B, when the second glass pane 108 is moved into contact with the pre-placed solder band/pieces 534, it will be appreciated that the upper surface 542 of the stand-offs 116 may not contact the interior surface 110 of the pane 108 (or alternatively, may not contact the low-e coating 128 of the pane, if present).

Referring now to FIG. 5C, the VIGU 500 is shown in substantially complete form (except the structural adhesive 122 is not shown). After bringing the pane 108 into contact with the pre-placed solder pieces 534 (FIG. 5B), the single soldering process required for assembly of the VIGU 500 is reflowing the pre-placed solder band/pieces 534 to create a continuous hermetic glass-to-metal seal between the solder pieces 534 and each of the interior surfaces 106, 110 of the glass panes 102, 108. During reflowing, the solid solder pieces 534 are heated to or above the liquidus temperature of the solder. Preferably, ultrasonic vibration energy is applied to the glass pane 102, glass pane 108 or both to “sonicate” the solder for improved bonding. In some embodiments, the panes 102, 108 are pressed towards one another while heating and/or while sonicating with ultrasonic vibration. Heat may be applied to either or both of glass panes 102 and/or 108 to raise the solder temperature to above its liquid temperature where the solder is in contact with the interior surface 110 of the glass pane 108. The solder of the pre-placed solder band/pieces 534 may also be heated by various means including, but not limited to induction heating and/or infrared heating during reflowing.

Preferably, the temperature of the glass panes 102, 108 in the region to be soldered to the solder band/pieces 534 is at or above the liquidus temperature of the solder in the band/pieces. If not, heat may be applied to either or both glass panes 102, 108 or the to-be-soldered contact surfaces 106, 110 in order to raise the temperatures of these surfaces. In some embodiments, ultrasonic energy may be applied to one or both lites 102, 108 when at least a portion of the solder of the solder band/pieces 534 is liquid and in contact with the interior surfaces 106 and/or 110, to cause the solder to become hermetically bonded to the interior surfaces 106 and 110. The interior surfaces 106 and 110 may or may not have a low-e coating 128 on the glass where the solder of the band/pieces 534 is bonded to those surfaces.

During reflowing, pressure may be applied to bias the two panes 102, 108 towards each other while the solder of the pre-placed solder pieces 534 is liquid, thereby causing the two panes to move until the interior surface 110 (including any low-e coating 128 or other performance enhancing coating thereon) contacts the top surfaces 542 of some or all of the stand-offs 116. This applied pressure may be supplied by the weight of second pane 108, or by an outside force applied perpendicular to the first outer surface 104, or by an outside force applied perpendicular to the second outer surface 112, or some combination of external forces applied perpendicular to both surfaces 104 and 112. During reflowing, the pre-placed solder pieces 534, which have the original height H_{O}, at least partially melt and subsequently solidify into the continuous metal seal 118, which has the final height H_{F}, where the value of H_{F} is less than the value of H_{O}. It is believed that allowing the final height H_{F} of the metal seal 118 to be determined by actual contact of the interior surfaces 106, 110 with the stand-offs 116 while the material of the seals is liquid provides VIGU 500 with improved tolerance for variation in the thickness of the glass panes 102, 108 and for variation in the height of the stand-offs 116 compared with VIGUs having a predetermined seal height.

In some embodiments, after the pre-placed solder pieces 534 of active metal-alloy solder are completely ultrasonically bonded to the interior surfaces 106 and 110 of panes 102 and 108, respectively, during reflowing, the solder is allowed, or alternatively forced, to cool to a temperature at or below its associated solidification temperature (thereby becoming the continuous metal seal 118). Allowing or forcing the solder to cool to or below its solidification temperature in a timely manner may require forced partial cooling of first lite 102 and/or second lite 108, or another method to cause the solder to become solid.

After the hermetic glass-to-metal seal has been formed between the metal seal element 118 and the interior surfaces 106, 110 of the glass panes 102, 108, the resulting inter-pane cavity 114 may be evacuated via the evacuation hole 126 (e.g., using a septum) to create a vacuum in the cavity. The channel 120 between the lateral outer edges of the metal element 118 and the lateral edges of the glass panes 102, 108 may be filled with the structural adhesive 122 (FIG. 1A) to increase the mechanical strength of the VIGU 500. Optionally, a relief cut 124 may be provided along the later edge of one or more of the glass panes 102, 108 to make the channel 120 wider, thereby simplifying placement of the structural adhesive 122 into the channel 120.

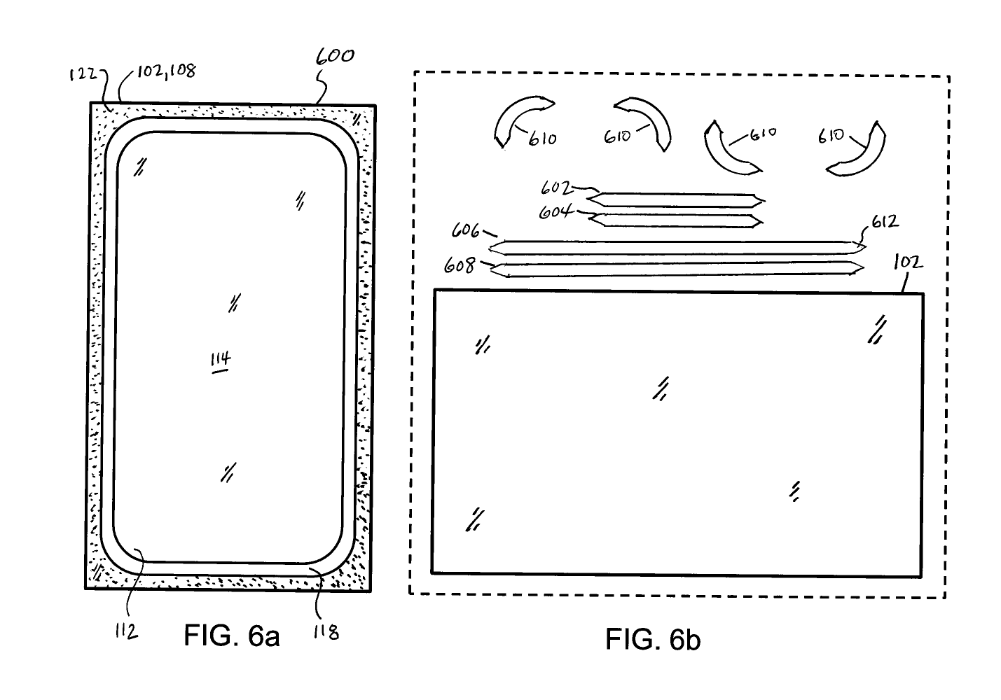

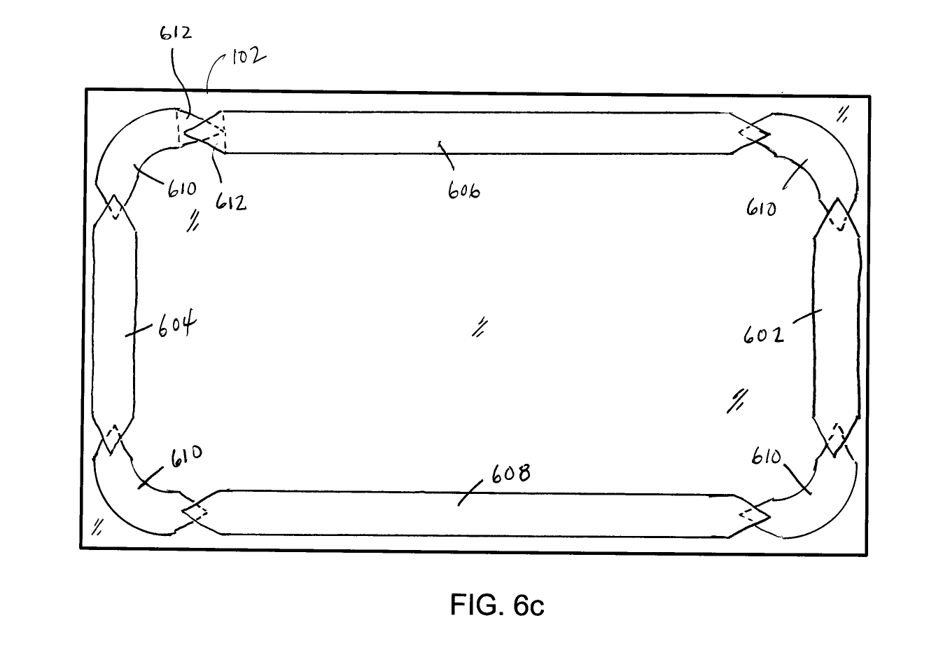

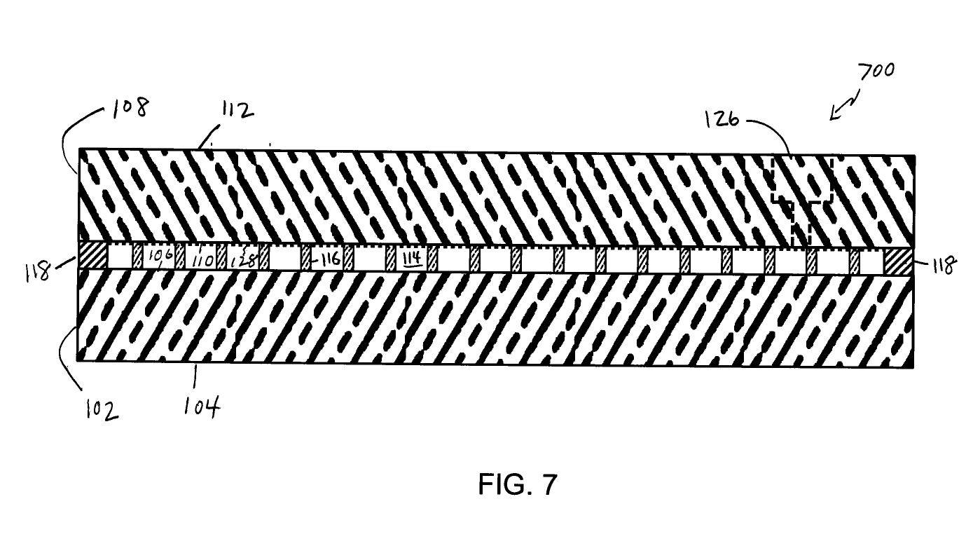

Referring now to FIGS. 6A-6C, there are illustrated the solder pieces required for producing one embodiment of a VIGU in accordance with the assembly method described herein in connection with FIGS. 5A-5C.

Referring first to FIG. 6A, there is illustrated a top view of a finished VIGU 600 including glass panes 102, 108, continuous metal seal 118 and structural adhesive 122. The continuous metal seal 118 surrounds the periphery of the inter-pane cavity 114, which is evacuated to a high-vacuum pressure level. The stand-offs 116 disposed within the cavity 114 are not shown in FIG. 6A because they are typically not visible in a completed VIGU.

Referring now to FIG. 6B, there are illustrated the solder pieces and one of the glass panes, in this case pane 102, required for assembly the VIGU 600. The solder pieces include four straight sections 602, 604, 606, 608 of active solder ribbons (having two different lengths for a non-square VIGU) and four rounded corners 610 of solder ribbons. As previously indicated, it may be desirable to use one or more active metal-alloy solder ribbons as the solid piece or pieces (e.g., pieces 534 of FIG. 5A) of active solder when performing the assembly of a VIGU as shown in FIGS. 5A-5C. When placed onto the pane 102, the eight solder ribbons 602, 604, 606, 608 and 610 shown in FIG. 6B may form a shape that conforms to the shape of the metal seal 118 needed for the rectangular lite 102 as shown in FIG. 6A. In some instances, one, two, three or all four corner sections 610 of the active solder ribbon may have right-angle or perpendicular corners, or one or more of the corner solder ribbon sections may have angles different than 90 degrees.

If the shape of the lites of the VIGU are non-rectangular, then one or more active metal-alloy solder ribbons 602-610 or combination of multiple pieces of solder ribbon may be used to conform to the outline shape of the VIGU.

Referring still to FIG. 6B, and also to FIG. 6C, there is shown one method of using four straight sections 602, 604, 606, 608 of solid ribbon solder and four rounded corner sections 610 of solid ribbon solder to create a constant or near-constant volume per unit length of solder ribbon. In this embodiment, both ends 612 of each section of all the pieces 602-610 of solder ribbon are shaped as identical triangles. When the solder ribbons 602-610 are placed on the glass lite 102, the triangular-shaped ends 612 of the solder ribbons 602-610 overlap each other by a distance equal to the length of the triangle portion. Accordingly, when two overlapping triangle ends 612 are reflow soldered together the sum of the volume of solder contained in two overlapping triangles 612 is equal to the volume of solder contained in the same length of an untapered portion of the solder ribbon. The similar volumes of melting solder result (aided by the pressure of a top lite 108 on the liquefied active metal-alloy solder) in a continuous solder band 118 having a relatively constant width, and more importantly, no gaps in the solder band. Shapes other than triangles may accomplish the same desired goal of having the widths of the eventually reflowed regions where the solder ribbons overlap each other become equal to the rest of the solder ribbon sections.

In yet another embodiment (not shown), a continuous hermetic metal seal having a glass-to-metal bond may be formed by depositing an active solder in its liquid or molten state onto the interior surface (e.g., surface 106 or 110) of one or more glass panes (e.g., panes 102 or 108) to be incorporated into a VIGU. Ultrasonic vibration may be applied to the liquid solder and/or glass panes during bonding of the solder to increase the hermeticity and/or strength of the resulting glass-to-metal bond.

In yet another embodiment (not shown), an active solder in its liquid or molten state may be droplet-jetted (in a fashion similar to ink-jetting) onto the interior surface (e.g., surface 106 or 110) of one or more glass panes (e.g., panes 102 or 108) to be incorporated into a VIGU. Ultrasonic vibration may be applied to the liquid solder and/or glass panes during bonding of the solder to increase the hermeticity and/or strength of the resulting glass-to-metal bond.

In yet another embodiment (not shown), a so-called “metallic glue” such as one of the low-temperature nanorod-based metallic adhesive materials described in International Publication No. WO 2014/205193 (incorporated by reference herein), entitled “Low-Temperature Bonding And Sealing With Spaced Nanorods,” may be substituted for one or both of the pre-tinned metal elements 334, 336 of the VIGU 300, for the pre-tinned metal element 434 of the VIGU 400, for the pre-placed solder band/pieces 534 of the VIGU 500 and/or for the solder ribbon pieces 602-610 of the VIGU 600. In certain embodiments, the use of the metallic glue may allow hermetic glass-to-metal bonds to be achieved at room temperature with only pressure or at a temperature above room temperature (e.g., about 150° C. or less) at reduced pressure. It is understood that such bonds may be both mechanically strong and substantially impermeable to oxygen and moisture.

Referring now to FIG. 7, there is illustrated a VIGU in accordance with another aspect. The VIGU 700 of FIG. 7 is substantially similar in construction to the VIGU 100 previously shown and described in connection with FIGS. 1A and 1B. In this respect, identical reference numbers will be used for identical elements. However, whereas the VIGU 100 includes a structural adhesive 122 disposed in a channel 120 between the panes 102, 108 outside the metal seal 118, the VIGU 700 does not include the structural adhesive. In the illustrated embodiment, the hermetically bonded metal seal 118 of the VIGU 700 is positioned flush with the lateral edges of the panes 102, 108; however, in other embodiments, the metal seal may be inset (e.g., as shown in FIG. 1A) such that a channel 120 is present. However, in such embodiments of VIGU 700 having a channel 120, no structural adhesive is included. It will be appreciated that elements including, but not limited to seals, fillers, paints, coatings and/or plugs of a non-structural nature may be positioned in the channel 120, if present, without departing from the current aspect.

It will be appreciated that the VIGU 700 may be assembled using any of the assembly methods described herein in connection with VIGUs 300, 400, 500 and 600, except that the application of the structural adhesive is omitted after the metal seal has been hermetically bonded to the glass panes.

Although the preferred embodiments have been described in detail, it should be understood that various changes, substitutions and alterations can be made therein without departing form the spirit and scope of the invention as defined by the appended claims.

1. A vacuum insulated glass unit (VIGU) comprising:
a first glass pane defining an interior surface and an exterior surface on opposite sides thereof and lateral edges extending therebetween;
a second glass pane defining an interior surface and an exterior surface on opposite sides thereof and lateral edges extending therebetween, the second glass pane being disposed such that the interior surface of the second glass pane opposes the interior surface of the first glass pane, the second glass pane further being spaced apart from the first glass pane to define an inter-pane gap between the opposing interior surfaces;
a first band of metal solder extending continuously between the opposing interior surfaces of the first and second glass panes and disposed continuously around the peripheries of the first and second glass panes but inset from the lateral edges of the first and second glass panes, whereby an inter-pane cavity is defined in a first portion of the inter-pane gap that is surrounded by the first band of metal solder and a channel is defined in a second portion of the inter-pane gap that is between the first band of metal solder and the lateral edges of the glass panes;
wherein the first band of metal solder is attached with a first hermetic glass-to-metal bond to the interior surface of first glass pane and is attached with a second hermetic glass-to-metal bond to the interior surface of the second glass pane, whereby the inter-pane cavity is hermetically sealed with respect to the first and second glass panes;
a plurality of stand-offs disposed within the inter-pane cavity and extending between the opposing interior surfaces of the first and second glass panes; and
a structural adhesive material disposed within the channel and extending between the opposing interior surfaces of the first and second glass panes and structurally bonding the first glass pane to the second glass pane across the inter-lite gap.

2. A VIGU in accordance with claim 1, further comprising:
a low emissivity coating disposed on substantially all of the interior surface of the second glass pane except for an edge-reduced region disposed in a continuous band around the perimeter of the second pane; and
whereby the second hermetic glass-to-metal bond from the first band of metal solder to the interior surface of the second glass pane is formed on a portion of the edge-reduced region.

3. A VIGU in accordance with claim 1, further comprising:
a low emissivity coating disposed on substantially all of the interior surface of the second glass pane; and
whereby the second hermetic glass-to-metal bond from the first band of metal solder to the interior surface of the second glass pane includes a portion of the low emissivity coating between the first band of metal solder and the interior surface of the second glass pane.

4. A VIGU in accordance with claim 1, further comprising:
a first relief cut formed in a portion of the interior surface of one of the glass panes bordering the lateral edge thereof, the first relief cut extending along the lateral edge, thereby reducing the thickness of the first-relief-cut portion of the glass pane by a first amount and increasing the thickness of the first-relief-cut portion of the inter-pane gap by the first amount;
wherein the structural adhesive material is disposed within the first-relief-cut portion of the inter-pane gap and the first band of metal solder is disposed in the remaining portion of the inter-pane gap; and
wherein the thickness of the structural adhesive material is greater than the thickness of the first band of metal solder.

5. A VIGU in accordance with claim 4, further comprising:
a second relief cut formed in a portion of the interior surface of one of the glass panes bordering the first relief cut, the second relief cut extending along the first relief cut, thereby reducing the thickness of the second-relief-cut portion of the glass pane by a second amount and increasing the thickness of the second-relief-cut portion of the inter-pane gap by the second amount, where the second amount is smaller than the first amount;
wherein the structural adhesive material is disposed within the first-relief-cut portion of the inter-pane gap and the first band of metal solder is disposed within the second-relief-cut portion of the inter-pane gap; and
wherein the thickness of the first band of metal solder is greater than the thickness of the remaining interior portion of the inter-pane gap.

6. A VIGU in accordance with claim 1, wherein the first band of metal solder is formed from a solder alloy including tin (Sn), silver (Ag), titanium (Ti) and magnesium (Mg).

7. A VIGU in accordance with claim 1, further comprising:
a second band of metal solder extending continuously between the opposing interior surfaces of the first and second glass panes and continuously spaced apart from the first band of metal solder, whereby an inter-band gap is defined between the first and the second bands of metal solder; and
wherein the second band of metal solder is attached with a third hermetic glass-to-metal bond to the interior surface of first glass pane and is attached with a fourth hermetic glass-to-metal bond to the interior surface of the second glass pane, whereby the inter-band gap is hermetically sealed with respect to the first and second glass panes.

8. A VIGU in accordance with claim 7, wherein the lateral width of the inter-band gap between the first and second metal solder bands is within a range from 1 μm to 500 μm.

9. A VIGU in accordance with claim 7, wherein the lateral width of the inter-band gap between the first and second metal solder bands is within a range from 500 μm to 1 mm.

10. A vacuum insulated glass unit (VIGU) comprising:
a first glass pane defining an interior surface and an exterior surface on opposite sides thereof and lateral edges extending therebetween;
a second glass pane defining an interior surface and an exterior surface on opposite sides thereof and lateral edges extending therebetween, the second glass pane being disposed such that the interior surface of the second glass pane opposes the interior surface of the first glass pane, the second glass pane further being spaced apart from the first glass pane to define an inter-pane gap between the opposing interior surfaces;
a first band of metal solder extending continuously between the opposing interior surfaces of the first and second glass panes and disposed continuously around the peripheries of the first and second glass panes, whereby an inter-pane cavity is defined in a first portion of the inter-pane gap that is surrounded by the first band of metal solder;
wherein the first band of metal solder is attached with a first hermetic glass-to-metal bond to the interior surface of first glass pane and is attached with a second hermetic glass-to-metal bond to the interior surface of the second glass pane, whereby the inter-pane cavity is hermetically sealed with respect to the first and second glass panes; and
a plurality of stand-offs disposed within the inter-pane cavity and extending between the opposing interior surfaces of the first and second glass panes.

11. A VIGU in accordance with claim 10, further comprising:
a low emissivity coating disposed on substantially all of the interior surface of the second glass pane except for an edge-reduced region disposed in a continuous band around the perimeter of the second pane; and
whereby the second hermetic glass-to-metal bond from the first band of metal solder to the interior surface of the second glass pane is formed on a portion of the edge-reduced region.

12. A VIGU in accordance with claim 10, further comprising:
a low emissivity coating disposed on substantially all of the interior surface of the second glass pane; and
whereby the second hermetic glass-to-metal bond from the first band of metal solder to the interior surface of the second glass pane includes a portion of the low emissivity coating between the first band of metal solder and the interior surface of the second glass pane.

13. A VIGU in accordance with claim 10, further comprising:
a first relief cut formed in a portion of the interior surface of one of the glass panes bordering the lateral edge thereof, the first relief cut extending along the lateral edge, thereby reducing the thickness of the first-relief-cut portion of the glass pane by a first amount and increasing the thickness of the first-relief-cut portion of the inter-pane gap by the first amount;
wherein the first band of metal solder is disposed within the first-relief-cut portion of the inter-pane gap; and
wherein the thickness of the first band of metal solder is greater than the thickness of the remaining interior portion of the inter-pane gap.

14. A VIGU in accordance with claim 10, wherein the first band of metal solder is formed from a solder alloy including tin (Sn), silver (Ag), titanium (Ti) and magnesium (Mg).

15. A VIGU in accordance with claim 10, further comprising:
a second band of metal solder extending continuously between the opposing interior surfaces of the first and second glass panes and continuously spaced apart from the first band of metal solder, whereby an inter-band gap is defined between the first and the second bands of metal solder; and
wherein the second band of metal solder is attached with a third hermetic glass-to-metal bond to the interior surface of first glass pane and is attached with a fourth hermetic glass-to-metal bond to the interior surface of the second glass pane, whereby the inter-pane cavity is further hermetically sealed with respect to the first and second glass panes.

16. A VIGU in accordance with claim 15, wherein the lateral width of the inter-band gap between the first and second metal solder bands is within a range from 1 μm to 500 μm.

17. A VIGU in accordance with claim 15, wherein the lateral width of the inter-band gap between the first and second metal solder bands is within a range from 500 μm to 1 mm.

18. A method for making a vacuum insulated glass unit (VIGU), the method comprising the following steps:
providing a first glass pane defining an interior surface and an exterior surface on opposite sides thereof and lateral edges extending therebetween;
providing a second glass pane defining an interior surface and an exterior surface on opposite sides thereof and lateral edges extending therebetween;
applying a first band of metal solder continuously around the periphery of the interior surface of the first glass pane but inset from the lateral edges of the first glass pane;
placing a plurality of stand-offs on the interior surface of the first glass pane disposed within the portion of the interior surface surrounded by the first band of metal solder;
positioning the second glass pane at a position proximate to, but spaced apart from, the first glass pane such that the interior surface of the second glass pane opposes the interior surface of the first glass pane to define an inter-pane gap between the opposing interior surfaces and defining an inter-pane cavity in that portion of the inter-pane gap surrounded by the first band of metal solder and defining a channel in that portion of the inter-pane gap between the first band of metal solder and the lateral edges of the glass panes;
forming a first hermetic glass-to-metal bond attaching the first band of metal solder to the interior surface of the first glass pane;
forming a second hermetic glass-to-metal bond attaching the first band of metal solder to the interior surface of second glass pane;
whereby the inter-pane cavity is hermetically sealed with respect to the first and second glass panes; and
inserting a structural adhesive into the channel, the structural adhesive extending between the opposing interior surfaces of the first and second glass panes and structurally bonding the first glass pane to the second glass pane across the inter-lite gap.

19. A method of making a VIGU in accordance with claim 18, wherein the step of applying a first band of metal solder further comprises pre-tinning the interior surface of the first glass pane with a band of metal solder continuously around the periphery of the interior surface of the first glass pane.

20. A method of making a VIGU in accordance with claim 18, wherein the step of applying a first band of metal solder further comprises placing solid pieces of metal solder around the periphery of the interior surface of the first glass pane.

21. A method of making a VIGU in accordance with claim 18, wherein the step of forming a first hermetic glass-to-metal bond further comprises:
heating the first band of metal solder sufficient to liquify at least portions of the first band of metal solder contacting the interior surface of the first glass pane continuously around the periphery of the first band of metal solder; and
applying ultrasonic vibrations to the liquified portions of the solder of the first band of metal solder in contact with the interior surface of the first glass pane.

22. A method of making a VIGU in accordance with claim 21, wherein the step of forming a second hermetic glass-to-metal bond further comprises:
heating the first band of metal solder sufficient to liquify at least portions of the first band of metal solder contacting the interior surface of the second glass pane continuously around the periphery of the first band of metal solder; and
applying ultrasonic vibrations to the liquified portions of the solder of the first band of metal solder in contact with the interior surface of the second glass pane.

23. A method of making a VIGU in accordance with claim 18, further comprising:
applying a second band of metal solder on the interior surface of the first glass pane, the second band of metal solder being continuously spaced apart from the first band of metal solder, whereby an inter-band gap is defined between the first and second bands of metal solder;
forming a third hermetic glass-to-metal bond attaching the second band of metal solder to the interior surface of the first glass pane;
forming a fourth hermetic glass-to-metal bond attaching the second band of metal solder to the interior surface of second glass pane; and
whereby the inter-band gap is hermetically sealed with respect to the first and second glass panes.

24. A method for making a vacuum insulated glass unit (VIGU), the method comprising the following steps:
providing a first glass pane defining an interior surface and an exterior surface on opposite sides thereof and lateral edges extending therebetween;
providing a second glass pane defining an interior surface and an exterior surface on opposite sides thereof and lateral edges extending therebetween;
applying a first band of metal solder continuously around the periphery of the interior surface of the first glass pane but inset from the lateral edges of the first glass pane;
applying a second band of metal solder continuously around the periphery of the interior surface of the second glass pane but inset from the lateral edges of the second glass pane
placing a plurality of stand-offs on the interior surface of the first glass pane disposed within the portion of the interior surface surrounded by the first band of metal solder;
positioning the second glass pane at a position proximate to, but spaced apart from, the first glass pane such that the interior surface of the second glass pane opposes the interior surface of the first glass pane to define an inter-pane gap between the opposing interior surfaces and defining an inter-pane cavity in that portion of the inter-pane gap surrounded by the first band of metal solder and defining a channel in that portion of the inter-pane gap between the first band of metal solder and the lateral edges of the glass panes, and further such that the first band of metal solder at least partially overlaps the second band of metal solder continuously around the periphery of the first band of metal solder;
forming a first hermetic glass-to-metal bond attaching the first band of metal solder to the interior surface of the first glass pane;
forming a second hermetic glass-to-metal bond attaching the first band of metal solder to the interior surface of second glass pane;
forming a hermetic solder bond attaching the first band of metal solder to the second band of metal solder;
whereby the inter-pane cavity is hermetically sealed with respect to the first and second glass panes; and
inserting a structural adhesive into the channel, the structural adhesive extending between the opposing interior surfaces of the first and second glass panes and structurally bonding the first glass pane to the second glass pane across the inter-lite gap.

25. A method for making a vacuum insulated glass unit (VIGU), the method comprising the following steps:
providing a first glass pane defining an interior surface and an exterior surface on opposite sides thereof and lateral edges extending therebetween;
providing a second glass pane defining an interior surface and an exterior surface on opposite sides thereof and lateral edges extending therebetween;
applying a first band of metal solder continuously around the periphery of the interior surface of the first glass pane but inset from the lateral edges of the first glass pane;
placing a plurality of stand-offs on the interior surface of the first glass pane disposed within the portion of the interior surface surrounded by the first band of metal solder;
positioning the second glass pane at a position proximate to, but spaced apart from, the first glass pane such that the interior surface of the second glass pane opposes the interior surface of the first glass pane to define an inter-pane gap between the opposing interior surfaces and defining an inter-pane cavity in that portion of the inter-pane gap surrounded by the first band of metal solder;
forming a first hermetic glass-to-metal bond attaching the first band of metal solder to the interior surface of the first glass pane;
forming a second hermetic glass-to-metal bond attaching the first band of metal solder to the interior surface of second glass pane; and
whereby the inter-pane cavity is hermetically sealed with respect to the first and second glass panes.
